(19) United States
(12) Patent Application Publication
(10) Pub. No.: US 2024/0270468 A1
(43) Pub. Date: Aug. 15, 2024

(54) COMPOSTABLE COMPOSITIONS, ARTICLES AND METHODS OF MAKING COMPOSTABLE ARTICLES

(71) Applicant: 3M INNOVATIVE PROPERTIES COMPANY, St. Paul, MN (US)

(72) Inventors: Ignatius A. Kadoma, Cottage Grove, MN (US); Sithya S. Khieu, Eden Prairie, MN (US); Rajdeep S. Kalgutkar, Woodbury, MN (US); Stephen M. Sanocki, Stillwater, MN (US); Yaohua Gao, Woodbury, MN (US); Annabelle Watts, Minneapolis, MN (US); Satinder K. Nayar, Woodbury, MN (US); Verlin W. Schelhaas, New Richmond, WI (US); Timothy J. Rowell, St. Paul, MN (US); Jeffrey E. Zelinsky, Woodbury, MN (US); Kimberly C.M. Schultz, Woodbury, MN (US); Lori-Ann S. Prioleau, St. Paul, MN (US); Kenneth P. Morris, Cottage Grove, MN (US)

(21) Appl. No.: 18/618,917

(22) Filed: Mar. 27, 2024

Related U.S. Application Data
(62) Division of application No. 17/917,681, filed on Oct. 7, 2022.
(60) Provisional application No. 63/074,617, filed on Sep. 4, 2020.
(60) Provisional application No. 63/047,489, filed on Jul. 2, 2020.
(60) Provisional application No. 63/047,450, filed on Jul. 2, 2020.
(60) Provisional application No. 63/011,024, filed on Apr. 16, 2020.
(60) Provisional application No. 63/010,092, filed on Apr. 15, 2020.
(60) Provisional application No. 63/010,088, filed on Apr. 15, 2020.

(51) Int. Cl. B65D 65/46; B31B 70/64; B31B 170/20; B32B 3/30; B32B 5/02; B32B 27/10; B32B 27/12; B32B 27/18; B32B 27/36; B32B 29/00; B65D 33/18; C09D 7/61; C09D 7/65; C09D 167/02; D04H 3/009; D04H 3/16

(52) U.S. Cl. CPC B65D 65/466; B31B 70/64; B32B 3/30; B32B 5/022; B32B 27/10; B32B 27/12; B32B 27/18; B32B 27/36; B32B 29/00; B65D 33/18; C09D 7/61; C09D 7/65; C09D 167/02; B31B 2170/20; B32B 2262/0276; B32B 2262/124; B32B 2264/101; B32B 2264/1026; B32B 2264/1027; B32B 2264/104; B32B 2264/107; B32B 2270/00; B32B 2307/31; B32B 2307/54; B32B 2307/558; B32B 2307/712; B32B 2307/7163; B32B 2307/7246; B32B 2307/7265; B32B 2439/46; D04H 3/009; D04H 3/16; D10B 2331/04; D10B 2505/10

(57) ABSTRACT

The present application relates to compostable articles and compositions including at least one biodegradable polymer and a hydrophobic agent. In some embodiments, the compostable articles and compositions include a second biodegradable polymer, different from the first biodegradable polymer. In some embodiments, the first biodegradable polymer is selected from the group consisting of poly(ethylene succinate) (PES), poly(trimethylene succinate) (PTS), poly(butylene succinate) (PBS), poly(butylene succinate co-butylene adipate) (PBSA), poly (butylene adipate co-terephthalate) (PBAT), poly(tetramethylene adipate-co-terephthalate) (PTAT), and thermoplastic starch. In some embodiments, the presently described articles include packaging.

### CROSS REFERENCE TO RELATED APPLICATIONS

This application is a divisional of pending prior U.S. application Ser. No. 17/917,681, filed 7 Oct. 2022, which is a national stage filing under 35 U.S.C. 371 of PCT/US2021/027296, filed 14 Apr. 2021 which claims priority to U.S. Provisional Application No. 63/074,617, filed 4 Sep. 2020, and which claims priority to U.S. Provisional Application No. 63/047,489 filed 2 Jul. 2020 and which claims priority to U.S. Provisional Application No. 63/047,450 filed 2 Jul. 2020, and which claims priority to U.S. Provisional Application No. 63/011,024, filed 16 Apr. 2020, and which claims priority to U.S. Provisional Application No. 63/010,092 filed 15 Apr. 2020, and which claims priority to U.S. Provisional Application No. 63/010,088 filed 15 Apr. 2020, the disclosure of which is incorporated by reference in its/their entirety herein.

### TECHNICAL FIELD

The present disclosure relates generally to compostable compositions, compostable articles and methods of making compostable articles.

### BACKGROUND

Many limited use or disposable products manufactured today require components that are formed by extrusion and/or molding (e.g., injection molding, blow molding). By limited use or disposable, it is meant that the product and/or component is used only a small number of times or possibly only once before being discarded. Exemplary disposable products include flexible films made from plastic which are widely used for packaging a variety of products. In some instances, such flexible films may form air or liquid barriers to prevent degradation and contamination of food items. Requirements for food packaging include ensuring that the package remains intact for extended periods of time. As a result, polymer-based flexible films are usually non-biodegradable and non-recyclable. The disposal of this non-biodegradable and non-recyclable (non-renewable) waste is a pressing environmental challenge.

Previous attempts to provide biodegradable products relied on, for example, blending polymers to achieve the desired mechanical properties. U.S. Pat. No. 5,910,545 describes a biodegradable thermoplastic blend, including poly(lactic acid) and polybutylene succinate (PBS), and a wetting agent exhibiting a hydrophilic-lipophilic balance ratio between 10 to 40. U.S. Pat. No. 10,081,168 describes packaging materials, including at least one polymer coating layer containing at least 70 weight percent of polylactide (PLA) and at least 5 weight percent of polybutylene succinate (PBS) or its derivate blended therewith. U.S. Patent Publications US20180229917, US20180086538, U.S. Pat. Nos. 10,235,3458, 9,957,098, US20190328857, US20200024061, and US20180194534 relate to compostable containers.

### SUMMARY

There continues to be a need to provide compostable yet durable compositions and articles. By “durable” compositions, it is meant compositions that can be formed into different articles including packaging articles that withstand transport and have a useful shelf life. In one aspect, the present inventors developed compostable compositions and articles that surprisingly display high water repellency. In another aspect, the articles of the present application are weather resistant and suitable for use as packaging.

The present application relates to durable yet compostable articles comprising a first biodegradable polymer and a hydrophobic agent. In some embodiments, the compostable articles additionally comprise a second biodegradable polymer, different from the first biodegradable polymer. In some embodiments, the hydrophobic agent is a biodegradable hydrophobic agent. In some embodiments, the first biodegradable polymer is selected from the group consisting of poly(butylene succinate), poly (butylene succinate adipate), poly(ethylene succinate), poly(tetramethylene adipate-co-terephthalate), and thermoplastic starch.

Compostable compositions of the present disclosure may be made from formulations that include at least 40 percent by weight (“40 wt. %”), at least 45 wt. %, at least 50 wt. %, at least 55 wt. %, at least 60 wt. %, or at least 65 wt. % of a biodegradable polymer. In some embodiments, compostable compositions of the present disclosure may be made from formulations that include greater than 50 wt. %, greater than 60 wt. %, greater than 70 wt. %, 25 greater than 80 wt. % (e.g., 90 wt. %) of a biodegradable polymer. Such compositions may be prepared, for example, by combining biodegradable thermoplastics such as, for example, a first biodegradable polymer (e.g., polybutylene succinate, “PBS”) and a second biodegradable polymer (e.g., polylactic acid, “PLA”) with a hydrophobic agent (e.g., hydrogenated castor oil derived from castor beans) and an inorganic filler sourced from natural deposits (e.g., calcium carbonate, hydrated magnesium silicate).

The disclosed compostable compositions may be molded into a variety of shapes, may be compostable in consumer and/or industrial composting facilities, and are typically suitable for use in variety of applications, including but not limited to those applications involving food and/or food preparation, shipping and personal hygiene items. In some embodiments, the compostable articles are used for food packaging and provide a liquid barrier to prevent contamination and untimely degradation of food items contained therein.

Features and advantages of the present disclosure will be further understood upon consideration of the detailed description as well as the appended claims.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic of an exemplary compostable article.

FIG. 2 is a schematic of another exemplary compostable article.

FIG. 3 is a schematic of yet another exemplary compostable article.

FIGS. 4A and 4B are schematics of an exemplary compostable article with a flap in the open (4A) and closed (4B) configurations.

FIG. 5 is a schematic of an exemplary compostable article with an adhesive portion.

FIG. 6 is a schematic of an exemplary compostable article with two adhesive portions on a flap.

FIG. 7 is a perspective cross-sectional view of an exemplary compostable article according to the present disclosure.

FIG. 8 is a photograph of an exemplary compostable article comprising a pattern and prepared as described in Example 13A, below.

FIG. 9 is a photograph of an exemplary compostable article comprising a pattern prepared as described in Example 13B, below

FIG. 10 is a photograph of an exemplary compostable article comprising a pattern and prepared as described in Example 23, below.

FIG. 11 is a cross-section of an exemplary compostable article.

FIGS. 12a-12C are cross-sections of exemplary compostable articles including microstructures.

FIG. 13 is a cross-section of an exemplary compostable article including microstructures.

FIG. 14 is a cross-section of an exemplary compostable article including microstructures.

### DETAILED DESCRIPTION

Some terms in this disclosure are defined below. Other terms will be familiar to the person of skill in the art and should be afforded the meaning that a person of ordinary skill in the art would have ascribed to them.

Terms indicating a high frequency, such as (but not limited to) “common,” “typical,” and “usual,” as well as “commonly,” “typically,” and “usually” are used herein to refer to features that are often employed in the invention and, unless specifically used with reference to the prior art, are not intended to mean that the features are present in the prior art, much less that those features are common, usual, or typical in the prior art.

Throughout this disclosure, singular forms such as “a,” “an,” and “the” are often used for convenience; however, the singular forms are meant to include the plural unless the singular alone is explicitly specified or is clearly indicated by the context. When the singular alone is called for, the term “one and only one” is typically used.

As used herein, the term “or” is generally employed in its usual sense including “and/or” unless the content clearly dictates otherwise. The term “and/or” means one or all of the listed elements or a combination of any two or more of the listed elements.

As used herein, a material is “biodegradable” when it degrades or decomposes as a result of exposure to the environmental effects of sunlight, heat, water, oxygen, pollutants, microorganisms, enzymes, insects and/or animals.

As used herein, a material is “compostable” when it meets the requirements of ASTM D6400-19 or ASTM D6868, or both. It should be noted that those two standards are applicable to different types of materials, so the material, composition, or article need only meet one of them, usually whichever is most applicable, to be “compostable” as defined herein. In addition to meeting the ASTM D6400 or ASTM D6868 standards, compostable materials, compositions, or articles can optionally meet one or more of the following standards: ASTM D5338, EN 12432, AS 4736, ISO 17088, or ISO 14855. It should be noted that the term “compostable” as used herein is not interchangeable with the term “biodegradable.” Something that is “compostable” must degrade within the time specified by the above standard or standards into materials having a toxicity, particularly plant toxicity, that conform with the above standard or standards. The term “biodegradable” does not specify the time in which a material must degrade nor does it specify that the compounds into which it degrades pass any standard for toxicity or lack of harm to the environment. For example, materials that meet the ASTM D6400 standard (i.e., compostable materials) must pass the test specified in ISO 17088, which addresses “the presence of high levels of regulated metals and other harmful components,” whereas a material that is “biodegradable” may have any level of harmful components.

As used herein, the term “packaging” refers to any items which are used to transport, store, or protect goods. Examples of packaging according to the present disclosure include, without limitation, wrappers, pouches, bags, envelopes and the like. In some embodiments, packaging is used to protect food items.

Parts for common household items (e.g., bottles, cups, containers, utensils) may be formed from various grades of polymers derived from petrochemicals (i.e., petrochemical-based polymers) such as, for example, polystyrene, polypropylene, and polycarbonate. To reduce the environmental impact, these parts may be made utilizing recycled resin streams. However, concerns about the ongoing depletion of fossil resources and the global warming associated with the use of petrochemicals continue to fuel the development of new biodegradable polymers, as biodegradable polymers typically have a relatively low CO₂ footprint and may desirably be associated with the concept of sustainability. Moreover, consumers have shown an interest in and desire for compostable options for formed parts that may be used in, for example, household items, packaging, food-contacting applications, and/or parts that may be difficult to recapture into a recycle stream (e.g., meat packaging, medical packaging, dental packaging).

Packaging articles, particularly those designed for shipping such as mailers, envelopes, bags, and pouches, may be made of compostable or recyclable paper. However, paper is durable, that is, it is not water or weather resistant. As a result, paper articles are unacceptable for many packaging and shipping applications, particularly for applications involving environments where the packaging may be exposed to inclement weather, for example, during shipping or delivery. Plastic or plastic containing packaging and shipping articles that may be weather resistant (i.e., durable) are not compostable and thus most end up as landfill waste. Even those plastic packaging and shipping articles that can be recycled are often not recycled, and when they are the recycling process can be expensive and time consuming.

Biodegradable food packaging articles are known. Previous attempts to produce less environmentally impactful packaging relied on naturally occurring polymers (e.g., polysaccharides such as cellulose-based, starch-based). However, in some instances, the polymers degraded too quickly to be considered durable and effectively used as food packaging. In other instances, the polymers were hydrophilic and did not provide adequate air and/or moisture barriers to the packaged items. PCT Publication No. WO 91/06601, for example, describes biodegradable polymer compositions containing one or more polymers and a filler. The filler contains a degradation-enhancing material including cracking agents, such as surfactants, and a biodegradable safening material. PCT Publication No. WO 93/00601 describes biodegradable films comprised of starch and water. PCT Publication No. WO 96/03886 describes biodegradable moldings for packaging food or non-food products. The moldings contain a self-supporting base, obtained by baking a suspension based on a starch product, and a water-resistant film made of wax components.

In one aspect, the present disclosure recognizes a problem of providing a compostable packaging article, such as a shipping article or food packaging article, that can provide some weather, water or moisture resistance. This disclosure also recognizes the problem that it can be difficult to seal the edges of a compostable sheet, especially by well known, rapid, and inexpensive heat-sealing processes, to make a compostable article such as a bag, pouch, or envelope that has one open edge and one or more sealed edges.

Briefly, a solution to some or all of these problems, as well as to other problems that may or may not be specified in this disclosure, lies in compostable compositions and articles. Compostable compositions and articles of the present disclosure may be made from formulations that include at least 40 percent by weight (“40 wt. %”), at least 45 wt. %, at least 50 wt. %, at least 55 wt. %, at least 60 wt. %, or at least 65 wt. % of a first biodegradable polymer, which is more particularly a first compostable polymer and a hydrophobic agent, which is more particularly a first compostable hydrophobic agent. In some embodiments, compostable compositions and articles of the present disclosure may be made from formulations that include greater than 50 wt. %, greater than 60 wt. %, greater than 70 wt. %, greater than 80 wt. % (e.g., 90 wt. %) of the first biodegradable polymer, and more particularly of the first compostable polymer. In some embodiments, the compostable compositions additionally include a second biodegradable polymer, which is more particularly a second compostable polymer. For example, a first biodegradable polymer (e.g., polybutylene succinate, “PBS”) and a second biodegradable polymer (e.g., polylactic acid, “PLA”) with a hydrophobic agent (e.g., hydrogenated castor oil derived from castor beans). In some embodiments, an inorganic filler sourced from natural deposits (e.g., calcium carbonate, hydrated magnesium silicate) is added.

The disclosed compositions may be molded into a variety of shapes, may be compostable in consumer and/or industrial composting facilities, and are typically suitable for use in variety of applications, including but not limited to those applications involving food and/or food preparation.

In one aspect, a compostable article according to the present application is a packaging article comprising a first wall having a first interior surface and a first exterior surface opposite the first interior surface as well as a second wall having a second interior surface and a second exterior surface opposite the second interior surface. The first and second interior surfaces define an interior of the packaging article and the first and second exterior surfaces define an exterior of the packaging article. The packaging article has one or more edges where first wall is attached to the second wall. Optionally, the article may have at least one opening where the first wall is not attached to the second wall; this is not required in all cases because it is possible to form the packaging article around an object to be placed in the interior of the packaging article thereby eliminating the need for an article with an opening. The first or second wall consists of compostable materials comprising the first biodegradable polymer and the hydrophobic agent. In some embodiments the first and the second walls consist of the compostable materials. In some embodiments, the packaging article further includes compostable coatings. In some embodiments, the compostable coatings comprise a compostable heat-sealable coating.

### Biodegradable Polymers:

Compostable compositions and articles of the present disclosure include a first biodegradable polymer, and optionally, a second biodegradable polymer different from the first biodegradable polymer. In some embodiments, the first biodegradable polymer is an aliphatic polyester. In some embodiments, the aliphatic polyester is prepared from succinic or adipic acids. In some embodiments, the first biodegradable polymer is selected from the group consisting of poly(ethylene succinate) (PES), poly(trimethylene succinate) (PTS), poly(butylene succinate) (PBS), poly(butylene succinate co-butylene adipate) (PBSA), poly (butylene adipate co-terephthalate) (PBAT), poly(tetramethylene adipate-co-terephthalate) (PTAT). In some embodiments, the first biodegradable polymer is poly(butylene succinate). In other embodiments, the first biodegradable polymer is a thermoplastic starch. In any of the foregoing embodiments, the first biodegradable polymer is particularly compostable, i.e., it is a first compostable polymer.

In some embodiments, the second biodegradable polymer is selected from the group consisting of polylactide (PLA), polyglycolide (which is used herein to include both polyglycolide and poly glycolic acid), polycaprolactone, and copolymers or two or more of polylactide, polyglycolide, and polycaprolactone. In some embodiments, the second biodegradable polymer is selected from the group consisting of zein, cellulosic ester, a polyhydroxyalkanoate, a polyhydroxyvalerate, polyhydroxyhexanoate, poly(ethylene succinate) (PES), poly(trimethylene succinate) (PTS), poly(butylene succinate) (PBS), poly(butylene succinate co-butylene adipate) (PBSA), poly (butylene adipate co-terephthalate) (PBAT), poly(tetramethylene adipate-co-terephthalate) (PTAT), thermoplastic starch, and combinations thereof. In some embodiments, the first biodegradable polymer comprises polybutylene succinate and the second biodegradable polymer comprises polylactide. In other embodiments, the compostable composition consists essentially of polybutylene succinate and a hydrophobic agent. In some embodiments, the hydrophobic agent is a compostable hydrophobic agent.

Compostable compositions and articles of the present disclosure typically comprise 40 wt. % to 75 wt. %, optionally 45 wt. % to 70 wt. %, or optionally 50 wt. % to 60 wt. % of the total weight of the first and second biodegradable polymers, which are particularly first and second compostable polymers. In some embodiments, the ratio of the weight percent of the first biodegradable polymer, particularly the first compostable polymer, to the second biodegradable polymer, particularly the second compostable polymer, in the composition is from 0.5:1 to 1.5:1, optionally from 0.75:1 to 1.25:1, or optionally 1:1, 0.1:1, 0.2:1, 2:1, 5:1 and 10:1.

The term “PLA” is meant to include both polylactide and polylactic acid.

Polybutylene succinate (PBS) is a thermoplastic aliphatic polyester that decomposes naturally into water and carbon dioxide in the presence of microorganisms, such as, for example, Amycolatopsis sp. HT-6, and Penicillium sp. Strain 14-3. While uses for PBS include packaging, its hydrophilicity renders it unsuitable as a proper moisture barrier and not durable enough to be used in packaging applications.

### Hydrophobic Agent:

Compostable compositions of the present disclosure desirably include a hydrophobic agent. Though not wishing to be bound by a particular theory, it is believed that the hydrophobic agent may impart useful characteristics to the disclosed compositions, such as, for example enhancement of mold release when the composition is used in an injection molding process, and hydrophobicity.

Examples of suitable hydrophobic agents include both bio-based and petroleum-based hydrophobic agents. Exemplary hydrophobic agents include, but are not limited to, ethylene bis(stearamide) (EBS), castor oil, hydrogenated castor oil (castor wax), soy wax, polyamitic acid, linoleic acid, arachidonic acid, palmitoleic, butyric acid, steric acid, triglycerides, paraffin or related petroleum-based hydrogenated hydrocarbons, and mixtures thereof. Particularly, any of the above-mentioned hydrophobic agents can be compostable.

Compostable compositions of the present disclosure include from 1 wt. % to 15 wt. %, optionally from 2 wt. % to 8 wt. %, or optionally from 2.5 wt. % to 6 wt. % (e.g., 4 wt. %) of a suitable hydrophobic agent, particularly one or more of the above-mentioned hydrophobic agents. In some embodiments, the composition may include at least 1 wt. %, at least 2 wt. %, or at least 2.5 wt. % of a suitable hydrophobic agent. In some embodiments, the composition may include less than 10 wt. %, less than 8 wt. %, or less than 6 wt. % of a suitable hydrophobic agent. In some embodiments, the hydrophobic agent is a biodegradable hydrophobic agent, and more particularly a compostable hydrophobic agent.

In one aspect, a coating, layer, or component of the presently described compostable articles were rendered hydrophobic due to the presence of between 0.5 and 15 polymer weight of at least one of a biodegradable hydrophobic agent or a compostable hydrophobic agent. By “hydrophobic”, it is meant that the compostable articles of the present application exhibited an advancing water contact angle of at least 90°.

### Fillers

Compostable compositions of the present disclosure may include at least one filler. When used, the filler is typically selected to impart useful characteristics to the disclosed compositions, such as, for example addition of the filler may allow for modification of the Young's modulus (ksi), %-elongation, and stress at break (“psi”) of the compostable composition.

Fillers suitable for use in embodiments of the present disclosure are known to those of ordinary skill in the art and may include inorganic materials such as, for example, a calcium carbonate, a talc, a kaolin, a clay, alumina trihydrate, calcium sulfate, a glass bubble, ground mica, zeolites, calcium phosphate, and combinations thereof.

Other fillers useful in embodiments of the present disclosure may include biodegradable fibers, such as, for example, wood fibers, wood pulp, bamboo fibers, and combinations thereof.

In preferred embodiments the compostable composition includes from 10 wt. % to 60 wt. %, optionally from 12 wt. % to 55 wt. %, or optionally from 14 wt. % to 50 wt. % of the filler. In some embodiments, the compostable composition includes at least 10 wt. %, at least 12 wt. %, or at least 14 wt. % of the filler. In some embodiments, the compostable composition includes at most 60 wt. %, at most 55 wt. %, or at most 50 wt. % of the filler. Use of the filler is optional, because in some embodiments the compostable composition can have suitable or desired properties even without using a filler.

Fillers useful in embodiments of the present compostable compositions may exist in a variety of shapes (e.g., spherical, rectangular, triangular, cylindrical, tubular, fibrous, platelet, flake). Fillers useful in embodiments of the present compostable compositions may also exist in a variety of sizes. For example, useful fillers may have an median particle size of from 0.1 μm to 10 μm, optionally from 0.25 μm to 8 μm, optionally from 0.5 μm to 6 μm, optionally from 0.75 μm to 4 μm, or optionally from 0.8 μm to 2 μm (e.g., 1.5 μm).

### Other Optional Components

The compostable composition optionally comprises additional components to impart characteristics that may be desirable in specific applications. Optional components may include, but are not limited to, other polymers (e.g., a polypropylene, a polyethylene, an ethylene vinyl acetate, a polyethylene terephthalate, a polymethyl pentene, and combinations thereof) where such polymer may include a third biodegradable polymer and/or a petrochemical-based polymer, a mold release agent, a flame retardant, an electrically conductive agent, an anti-static agent, a pigment, a dye, an antioxidant, an impact modifier, a stabilizer (e.g., a UV absorber), wetting agents, or any combination thereof.

Particularly, compostable pigments and dyes can be used. Examples include PLA masterbatch colorings available from Clariant Corp. (Minneapolis, MN, USA) under the OM or OMB lines of products, or those available from Techmer PM LLC (Clinton, TN, USA) under the PLAM or PPM lines of products. Typically, when colorings are employed, they are blended with the other compostable composition components at an amount of 0.5%-5% by weight.

### Composition Preparation

Compostable compositions of the present disclosure may be prepared by methods well known to those of ordinary skill in the relevant arts. For example, the first biodegradable polymer (e.g., PBS) may be compounded with the hydrophobic agent (e.g., hydrogenated castor oil) using a twin screw extruder (obtained under the trade designation “MP2030” from APV, now a part of Baker Perkins, Inc., Grand Rapids, MI, USA). Other components such as a second biodegradable polymer (e.g., PLA) and an inorganic filler may be added to the extruder feed. Optional components may also be added during the compounding process. Upon exiting the twin screw extruder, the compostable composition may be pulled via a knurled nip roll through a water bath followed by pelletizing of the cooled composition using a rotary cutting blade. The pellets may be subjected to further processing such as, but not limited, to injection molding, blow molding, injection blow molding, or profile extrusion by known methods to provide shaped articles.

The compostable composition can be prepared by other methods as well, such as by mixing liquid solutions or dispersions of the components and subsequently drying (e.g., after casting a film of the composition). Other suitable methods of preparing the compostable compositions are also possible. The method of preparation chosen may depend on the desired use or properties of the compostable compositions, and is readily determinable, for example, by a person skilled in the art of polymer or materials science.

### Articles

Any number of articles may be formed from compositions of the present disclosure. Such formed articles may include items such as, for example: trays and containers useful in food preparation and/or food storage; tape dispensers and tape cores; hooks such as those available commercially under the trade designation COMMAND from 3M Company, St. Paul, MN, USA; a flat tube formed into a roll, which can be used in automated systems such as ROLLBAG 3200 bagging machine (available from PAC Machinery, San Rafael, CA, US); rigid packaging containers both with and without fixed, separate, or living-hinge lids; and packaging material (e.g., a bag, envelope, pouch, or temporary corrugated box and carton closure systems and corner pieces) such as those commercially available under the trade designation BOX LATCH from Eco Latch Systems, LLC, Pewaukee, WI, USA.

In certain forms, such as packaging articles, examples of which include envelopes, mailers, pouches, tubes, and the like, the article can be completely closed, for example with an object inside it, or it can have an opening. In one particular embodiment, the compostable article of the present disclosure typically has two walls, a first wall and a second wall, each having an interior surface facing the interior of the article and an exterior surface facing the exterior of the article. Thus, the interior surface of the first wall (the “first interior surface”) faces the interior surface of the second wall (the “second interior surface”).

The two walls are typically made from a sheet of material, which may be a single layer of material or multiple layers of material. Each of the walls may be made of different sheets, in which case the two walls can be made from the same or different material. More commonly, the first and second walls are made of the same sheet of material that is folded to produce the two distinct walls. In these cases, the first and second walls can consist of the same materials. In some embodiments, the first wall or the second wall comprises a sheet prepared from the compostable compositions of the present application. In some embodiments, the first and the second walls are made from the compostable compositions.

The first wall and the second wall are attached along at least one edge of the packaging article. Depending on the configuration and shape of the article, they may be attached along two, three, four, or even more edges. The first wall and the second wall can be attached directly, such as being sealed together, or they may be attached indirectly by way of an intermediary structure such as a gusset, welt, or similar. The packaging article also includes an opening where the first and second walls are not attached.

The article, particularly packaging article, can include an opening where the first and second walls are not attached. However, openings are not required because it is also possible to form the packaging article around an object located in the interior thereby removing the need to make an article with an opening and subsequently close the opening.

Mechanisms or features may be present to facilitate easy opening of the packaging article after it is sealed. Examples include perforations, scoring, zip-tops, or embedded pull-strings or wires. When an opening or flap is present, one or more of these features may be present near the opening or flap to facilitate opening the packaging article near the opening or flap, or they may be present on a different part of the packaging article. While these features, when employed, are most commonly in a straight line parallel to at least one edge of the packaging article no particular configuration is required; other shapes or layouts can be used depending on the intended use of the packaging article.

The compostable articles formed from compositions of the present disclosure meet the ASTM D6400 standard. Additionally, or in the alternative, when the sheet articles are compostable, they can meet the ASTM D6868 standard. In addition to meeting one or both of the aforementioned standards, compostable formed articles can meet meets at least one of the EN 12432 standard, the AS 4736 standard, or the ISO 17088 standard. Particular compostable formed articles also meet the ISO 14855 standard.

### Fibrous Layers

In some embodiments, the compostable article includes a fibrous layer. The fibrous layer includes nonwoven and cellulosic materials such as paper, and cardboard. In some embodiments, the fibrous layer is biodegradable. Exemplary biodegradable fibrous layers and fibers include those made of polylactide (PLA), naturally occurring zein, polycaprolactone, cellulosic ester, polyhydroxyalkanoate (PHA) (e.g., poly-3-hydroxybutyrate (PHB), polyhydroxyvalerate (PHV), polyhydroxyhexanoate (PHH), poly(ethylene succinate) (PES), poly(trimethylene succinate) (PTS), poly(butylene succinate) (PBS), poly(butylene succinate co-butylene adipate) (PBSA), poly (butylene adipate co-terephthalate) (PBAT), poly(tetramethylene adipate-co-terephthalate) (PTAT), and mixtures thereof.

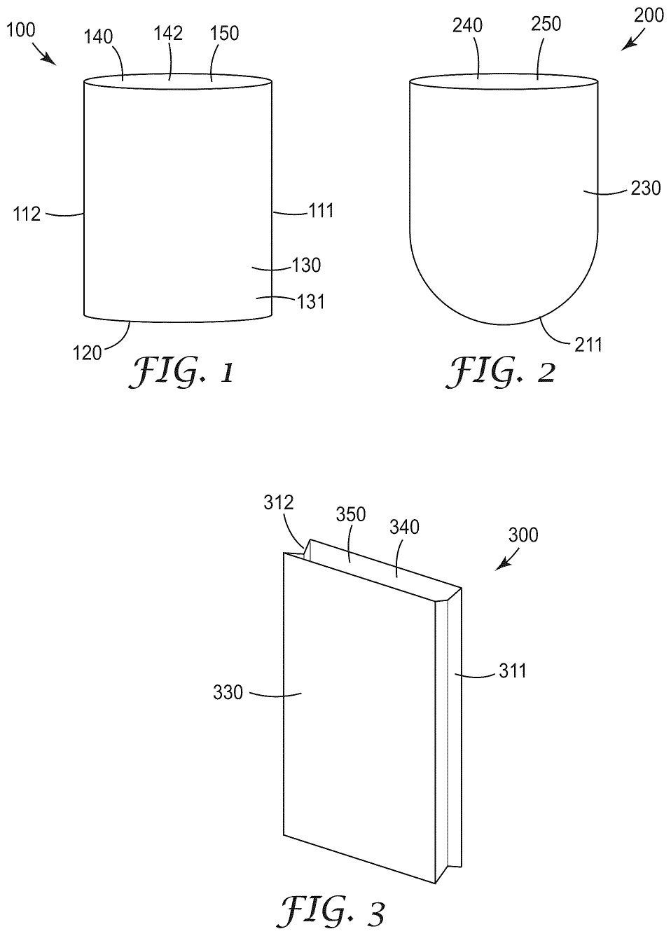

Suitable nonwovens include spunbond fabrics, melt-blown fabrics, spunlace, airlaid, wet-laid, carded and combinations thereof. Spunbond fibers are known in the art and refer to fabrics that are produced by depositing extruded, spun filaments onto a collecting belt in a uniform random manner followed by bonding the fibers. The fibers are separated during the layering process by air jets or electrostatic charges. Layers comprising spunbond fibers can be provided by techniques known in the art (e.g., using an apparatus generally as shown in FIG. 1 of U.S. Pat. No. 8,802,002 (Berrigan et al.), the disclosure of which is incorporated herein by reference) and are also commercially available, for example, under the trade designation “INGEO BIOPOLYMER 6202D” (polylactic acid fibers; spunbond scrim, smooth calendar) from Nature Works LLC, Minnetonka, MN. A standard melt-blown fiber forming process, as disclosed in, for example, U.S. Pat. Pub. No. 2006/0096911 (Brey et al.), the disclosure of which is incorporated herein by reference in its entirety. Blown microfibers (BMF) are created by a molten polymer entering and flowing through a die, the flow being distributed across the width of the die in the die cavity and the polymer exiting the die through a series of orifices as filaments. In one exemplary embodiment, a heated air stream passes through air manifolds and an air knife assembly adjacent to the series of polymer orifices that form the die exit (tip). This heated air stream can be adjusted for both temperature and velocity to attenuate (draw) the polymer filaments down to the desired fiber diameter. The BMF fibers are conveyed in this turbulent air stream towards a rotating surface where they collect to form a layer.

Particular fibrous layers that can be used have a basis weight that is sufficient to allow them to withstand weather conditions, such as heat, cold, rain, or snow, and other conditions and that may be encountered during a packaging and shipping process, as well as to withstand handling that may occur during packaging and shipping, such as dropping, jostling, banging against other objects, and the like. In some embodiments, the basis weight of the fibrous layer is from 6 to 300 g/m². When using nonwovens, any basis weight of nonwoven that is suitable for the intended use can be employed, and a variety of basis weights may be suitable depending on the needs of the users. Most commonly, the basis weight (in units of g/m²) will be no less than no less than 20, optionally no less than 30, optionally no less than 40, optionally no less than 50, optionally no less than 75, optionally no less than 100, optionally no less than 125, optionally no less than 150, optionally no less than 175, optionally no less than 200, optionally no less than 225, or optionally no less than 250. The basis weight (again in units of g/m²) is typically no greater than 250, optionally no greater than 225, optionally no greater than 200, optionally no greater than 175, optionally no greater than 150, optionally no greater than 125, optionally no greater than 100, optionally no greater than 75, optionally no greater than 50, optionally no greater than 40, or optionally no greater than 30. As an example the basis weight (again in units of g/m²) can be 20-250, more particularly the basis weight for nonwovens that are used can be 20-100 for nonwoven, and more particularly the basis weight for a cellulose-based wall can be 50-250.

Exemplary compostable articles including the first wall and second wall, such as any of those described herein, may comprise a fibrous layer. A particularly useful material that can be employed in the first wall, the second wall, or both, is cellulose. When used, the cellulose is typically a component of paper. Any form of paper can be employed in the first wall, the second wall, or both, as long as it is compostable. Kraft paper is particularly useful for this purpose, although other compostable papers may be used.

The first wall, second wall, or both may be constructed from a single layer or sheet of material or from multiple sheets. When a single layer or sheet is used, it is typically either PLA or paper. However, it is also possible to use any of the materials that are identified herein as second biodegradable polymers, as well as mixtures or blends thereof. Mixtures can refer to constructions where individual fibers have two more types of second biodegradable polymer, or it can refer to the use of two of more types of fiber, each having different components, in a single fibrous layer or sheet.

When multiple layers or sheets are used for the first wall, second wall, or both, they can be the same or different layers or sheets. Two, three, four, or even more layers or sheets can be used. In a configuration where there are two layers or sheets, one sheet is an inner layer or sheet disposed on the interior of the applicable wall, and the other layer or sheet is an exterior layer of sheet disposed on the exterior of the applicable wall. In a configuration where there are three layers or sheets, and additional intermediate layer or sheet is present between the inner and outer layers or sheets.

The layers or sheets can be coated with a compostable coating, such as any of the compostable coatings described herein and more particularly those compostable coatings that include a first biodegradable (particularly compostable) polymer and a hydrophobic agent, and more particularly compostable coatings comprising PBS and a hydrophobic agent. More details regarding the coatings that can be employed are provided below. At a minimum, at least one of the first interior or first exterior surface (of the first wall) or the second interior or second exterior surface (of the second wall) is coated with one or more coatings that consist of compostable coatings, and more specifically of a compostable heat-sealable coating. However, in many cases one or both sides of one, two, three, or more of the layers or sheets that constitute the first wall or the second wall are coated with compostable coatings.

The layers or sheets can be bonded together in any suitable way. The compostable coatings as discussed herein can be heat-sealable coatings, in which case the layers or sheets can be bonded together by a heat-sealing process, such as induction welding or impulse sealing. The coatings on the adjoining sides of the sheets or layers can have adhesive which can be used to laminate the sheets or layers. A patterned calendar roll can also be used to bond adjoining layers.

One or more of the layers or sheets can be flat layers or sheets. It is also possible that one or more of the layers or sheets can be embossed. An embossed layer or sheet can provide some cushioning for the contents of the packaging article, and so can be advantageous for certain uses. Any embossment pattern can be used, but most often a regular or repeating pattern is employed. Examples of repeating patterns are diamonds, squares, circles, triangles, hexagons, as well as mixed patterns with different shapes. When multiple layers or sheets are used, any or all of the layers or sheets can be embossed. Most commonly, when two layers or sheets are used the interior layer or sheet is embossed and the exterior layer or sheet is not embossed. When three layers or sheets are used, then typically either the intermediate or interior layer or sheet is embossed and the other layers or sheets are not embossed. However, other configurations are possible. For example, it might be useful in a three-layer construction emboss both the interior layer or sheet and the intermediate layer or sheet in order to provide additional cushioning beyond what is provided with only one embossed layer or sheet.

In some embodiments, the fibrous layer includes a sheet of loop material, which may be subsequently cut into pieces to form loop portions for fasteners. The sheet of loop material typically includes a backing comprising a thermoplastic backing layer with generally uniform morphology, and a sheet of longitudinally oriented fibers having generally non-deformed anchor portions bonded or fused in the thermoplastic backing layer at spaced bonding locations, and arcuate portions projecting from a front surface of the backing between the bonding locations.

In some embodiments, the fibers include core-sheath constructions, wherein the core and sheath may be made of the same material or different materials. Fibers of one material or fibers of different materials or material combinations may be used in the same sheet of fibers.

When the sheet of loop material is used to form loop portions of fasteners intended for limited use (i.e., for uses in which the fastener will ordinarily be opened and closed 10 times or less), preferably the arcuate portions of the sheet of fibers have a height from the backing of less than about 0.64 centimeters (0.250 inch) and preferably less than about 0.38 centimeters (0.15 inch); the width of the bonding locations should be between about 0.005 and 0.075 inch; and the width of the arcuate portions of the sheet of fibers should be between about 0.06 and 0.35 inch. Exemplary methods for making suitable loop materials are described in U.S. Pat. No. 5,256,231, the disclosure of which is incorporated herein by reference in its entirety.

### Compostable Coatings

Compostable articles according to the present application may further include a compostable coating, which in particular embodiments can also be a heat-sealable coating. For the packaging articles including the first wall and second wall, at least one of the first interior surface (of the first wall), the second interior surface (of the second wall), the first exterior surface (of the first wall), and the second exterior surface (of the second wall) may be coated with one or more compostable coatings. The compostable coatings comprise a compostable heat-sealable coating. Other layers or sheets may also be coated with any of the coatings discussed herein, or with other coatings that do not detract from the composability of the first and second walls.

The compostable, heat-sealable coating is typically a compostable composition as described herein. Thus, it typically comprises one or more of polybutylene succinate, poly (butylene succinate adipate), poly(ethylene succinate), poly(tetramethylene adipate-co-terephthalate), hydrogenated castor oil, or thermoplastic starch. Particularly, the compostable heat sealable coating comprises at least one of polybutylene succinate, poly (butylene succinate adipate), poly(ethylene succinate), hydrogenated castor oil, or poly(tetramethylene adipate-co-terephthalate). More particularly, the coating comprises polybutylene succinate, castor oil, such as hydrogenated castor oil, or both. The compostable, heat sealable coating can serve several purposes. It can be useful in forming the packaging article by allowing the edge or edges where the first wall is attached to the second wall to be heat sealed. It can also serve to provide weather or water resistance to the packaging article.

Other components can also be included in the coating. Particularly, compostable pigments and dyes can be used. Examples include PLA masterbatch colorings available from Clariant Corp. (Minneapolis, MN, USA) under the OM or OMB lines of products, or those available from Techmer PM LLC (Clinton, TN, USA) under the PLAM or PPM lines of products. Typically, when colorings are employed, they are blended with the other coating components at an amount of 0.5%-5% by weight.

There are at least two ways that coatings can be disposed on a layer or sheet. Both of these are important, and either one of them can be used with any embodiment of the article as described herein.

The first particular way of applying the coating to the underlying sheet or layer materials after the underlying sheet or layer has been formed, for example of any of the fibrous materials as discussed herein. This can be accomplished by any suitable method. Typically, extrusion is used.

The second particular way of applying the coating is to coat the individual fibers of the fibrous materials, sheet or layer with the coating. This results in a core-sheath configuration with the core as the sheet or layer material (or materials) and the sheath as the coating. A variety of ways of making core-sheath fibers are known in the art, and in principle any of these can be used depending on the components of the core and sheath. Further coatings can in principle be applied to the sheath, and this is within the scope of the coatings as described herein.

It is possible to use a combination of the foregoing two approaches in any embodiment of the articles described herein. Thus, in particular cases, the individual fibers are coated in a core-sheath type configuration and a coating, which can be the same or different coating from the sheath, is disposed on one or both sides of the layer or sheet of material made from the core-sheath fibers.

In either case, the coating need not be applied to the entire layer or sheet, but can be on only part of the layer or sheet. More particularly however, the coating is applied to the entirety of at least one side of the layer or sheet. Even more particularly, the coating, and most particularly a coating comprising polybutylene succinate, is applied to the entirety of both sides of the layer or sheet.

One particularly useful construction for one or more of the layers or sheets is a polylactic acid layer or sheet that is completely coated on both sides with polybutylene succinate, and more particularly with a mixture of polybutylene succinate and castor oil, optionally with one or more pigments or dyes as additional components of the coating. More particularly, the layers or sheets having a polylactic acid layer or sheet that is completely coated on both sides with polybutylene succinate can be embossed. Another particularly useful construction for the layers or sheets is a paper layer or sheet that is completely coated on both sides with polybutylene succinate. More particularly, the paper layer or sheet that is completely coated on both sides with polybutylene succinate can be embossed. In any of the layers or sheets that are completely coated on both sides, and particularly the foregoing polylactic acid or paper layers or sheets that are completely coated on both sides with polybutylene succinate, the coating can be in the form of a layer disposed on the layer or sheet of material or in the form of a sheath that is disposed on the fibers of the layer or sheet material.

Coating thicknesses, in micrometers, can be any thickness required to provide the desired properties but are typically between greater than 10, greater than 15, greater than 20, greater than 25, greater than 30, greater than 35, greater than 40, greater than 45, or even greater than 50. Coating thicknesses, in micrometers, are typically less than 60, less than 55, less than 50, less than 45, less than 40, less than 35, less than 30, less than 25, or even less than 20. An exemplary range for coating thickness, in micrometers, is 20 to 50. When the coating is a sheath over a core fiber, the “coating thickness” refers to the thickness of the sheath; when the coating is applied as a layer then it refers to the thickness of the layer.

### Microstructures

In some embodiments, the compostable article further includes microstructures. Compostable articles including microstructures unexpectedly display enhanced water repellency. Without wishing to be bound by theory, it is believed that these microstructures form channels on the surface of the biodegradable polymer layer, thereby impeding the entrance of water (i.e., preventing wetting of the surface). As a result, a high water contact angle is observed, and the compostable articles display increased hydrophobicity.

In some embodiments, microstructures may continuously extend throughout the length or width of the polymer layer, such as in, for example, rails. In other embodiments, the microstructures are discrete features, such as in, for example, hooks or pillars. Exemplary methods of creating microstructures are described on U.S. Pat. Nos. 5,053,028; 5,868,987; 6,000,106; 6,132,660; 6,417,294; and 7,168,139. Disclosures of these patents are incorporated herein by reference in their entireties.

In some embodiments, the microstructures include posts. In other embodiments, the microstructures include a stem and a cap. In some embodiments, the cap may have a cross section that is a rectangle, an oval, a circle or a semi-circle. In some embodiments, the cap has a greater width than the width of the stem. In some embodiments, the stem and cap are made from the same material. In other embodiments, the stem and cap are made from different materials. In some embodiments, the stem and cap are integral. In other embodiments, the stem and cap are separate components.

In some embodiments, the polymer layer and the microstructures are made from the same material. In other embodiments, material of the polymer layer is different from the material of the microstructures. “Different” as used herein means at least one of (a) a difference of at least 2% in at least one infrared peak, (b) a difference of at least 2% in at least one nuclear magnetic resonance peak, (c) a difference of at least 2% in the number average molecular weight, or (d) a difference of at least 5% in polydispersity. Examples of differences in polymeric materials that can provide the difference between polymeric materials include composition, microstructure, color, and refractive index. The term “same” in terms of polymeric materials means not different.

### Adhesive

In some embodiments, one or more adhesive portions can be provided on the compostable article. In some embodiments, adhesive portions are provided on articles comprising the first wall and the second wall, as previously described. In these articles, adhesive portions are provided on top of the walls. The adhesive portions are not considered to be part of the walls. Typically, when employed, the adhesive portions are near the opening in the packaging article, and can be used to close the article. If a flap is employed, the one or more adhesive portions are often on the flap, or on a portion of the exterior surface that can be reached by the flap when the flap is folded into the closed position, so as to allow the flap to be adhered into a closed position. In many cases two adhesive portions are provided.

The one or more adhesive portions are usually in the shape of a strip or strips that runs roughly parallel to the opening of the packaging article, but this is not required.

The one or more adhesive portions can be any suitable adhesive depending on the desired use but are most commonly compostable adhesive. In particular cases, the one or more adhesive portions consist of compostable adhesive. The one or more adhesive portions can be a water-activated adhesive or a pressure sensitive adhesive. Most particularly, a compostable pressure sensitive adhesive is employed. Exemplary compostable adhesives are known, and examples include a copolymer of 2-octylacrylate and acrylic acid; a copolymer of sugar-modified acrylates; a blend of polylactic acid, polycaprolactone, and resin; a blend of; poly(hydroxyalkanoate) and resin; protein adhesive; natural rubber adhesive; and polyamides containing dimer acid.

One or more release liners can be disposed over any or all the one or more adhesive portions. While it is advantageous that the release liners be compostable or at least recyclable, this is not required because the release liners can be disposed of separately from the packaging article after use and do not have to be placed with the packaging article in a composting environment. Thus, if the packaging articles as described herein have one or more release liners, the packaging articles can be “compostable” even if any or all of the release liners are not compostable.

### Phase Change Materials (PCMs)

Compostable compositions and articles of the present application may further include phase change materials (PCMs). PCMs are substances with a high heat of fusion that, when melting or solidifying, can store and release large amounts of energy at a certain temperature (that is, undergoing a phase change). During a phase change such as melting or freezing, molecules rearrange themselves and cause an entropy change that results in the absorption or release of latent heat. Throughout a phase change, the temperature of the material itself remains constant. Some exemplary common PCMs include salts, hydrated salts, fatty acids, and paraffins. Such PCMs, suitably packaged, may be used as thermal devices. Unlike dry or wet ice, however, most PCMs are not readily adaptable for shipping and transportation applications by themselves. They must be paired with an appropriate protective covering. Together, the PCM and protective covering form a packaging construction which will be able to protect the article to be transported at the desired temperature.

PCMs for use in the constructions of the present disclosure maintain the desired temperature of an article to be transported during shipment. As such, the one or more PCMs may have one or more of the following qualities: fine tunability over a wide range of physical properties; resilient to temperature and jostling during shipping; freezing without much supercooling; ability to melt congruently; compatibility with a variety of conventional materials; chemical stability; non corrosive; non-flammable; and nontoxic. In some embodiments, the PCM(s) are compostable and/or biodegradable. The PCM may take the form of a liquid, gel, hydrocolloid, or three-dimensional shape (e.g., a rectangle, square, or brick).

Some exemplary PCMs are as follows. Suitable PCMs may be organic or inorganic materials, including salts, hydrated salts, fatty acids, paraffins, and/or mixtures thereof. Because different phase change materials means for changing phases undergo phase change (or fusion) at various temperatures, the particular material that is chosen for use in the device may depend on the temperature at which the packaging is desired to be kept, which may include ranges between from about −135° C. to about 40° C. The desired range within this range may depend on the intended use of the packaging. For example, food cold chain packaging is typically between about −36° C. to about 25° C. Biologic or pharmaceutical cold chain packaging is typically between about −135° C. to about 40° C.

In some embodiments used for a cold chain, an approximately 20-23 weight percent salt solution comprising sodium chloride and water may be provided as the phase change material. This particular phase change material is characterized by a phase change temperature of fusion of from about −19° C. to about −21° C. Such temperature range may be suitable for use with the packaging and shipment of many pharmaceutical products, such as drugs, vaccines, and other active biologics.

Other exemplary phase change materials or means for changing phases useable in the present cold chain packaging, devices, and articles may include compositions produced in accordance with the process as described in U.S. Pat. No. 6,574,971, that have the desired phase change temperature and other characteristics described above. The materials of U.S. Pat. No. 6,574,971 include fatty acids and fatty acid derivatives made by heating and catalytic reactions, cooling, separating and recirculating. The reactant materials include a fatty acid glyceride selected from the group consisting of oils or fats derived from soybean, palm, coconut, sunflower, rapeseed, cotton seed, linseed, caster, peanut, olive, safflower, evening primrose, borage, carboseed, animal tallows and fats, animal greases, and mixtures thereof. In accordance with the processes of U.S. Pat. No. 6,574,971, the reaction mixture is a mixture of fatty acid glycerides that have different melting points and the reaction is an interesterification reaction, or the reaction mixture includes hydrogen and the reaction is hydrogenation, or the reaction mixture is a mixture of fatty acid glycerides and simple alcohols and the reaction is an alcoholysis reaction.

Additional exemplary PCMs include those listed in the following documents: U.S. Pat. Nos. 9,850,415; 9,914,865; 10,119,057; and 10,745,604, each of which is incorporated by reference in their entirety herein.

### DESCRIPTION OF THE FIGURES

FIG. 1 shows one exemplary compostable article construction 100 where two edges (111, 112) of the first 130 and second walls 140 are attached. In FIG. 1, article 100 is configured as a bag. First and second edges 111, 112 are attached directly, joining first wall 130 with second wall 140. Only the exterior surface 131 of first wall 130 and interior surface 142 of second wall 140 are visible in this figure. Opening 150 is present where the first and second walls 130, 140 are not attached. Bottom 120 is in this case defined by a fold in the sheet material that constitutes article 100.

FIG. 2 shows another construction where only one edge 211 of the first 230 and second 240 walls are attached. Here, exemplary article 200 is also configured as a bag. A single edge 211 attaches most of first and second walls 230, 240 while leaving them unattached at opening 250.

FIG. 3 shows a construction of exemplary packaging article 300 where edges 311, 312 are in the form of gussets that attach first and second walls 330, 340 while leaving opening 350 where the first and second walls 330, 340 are not attached.

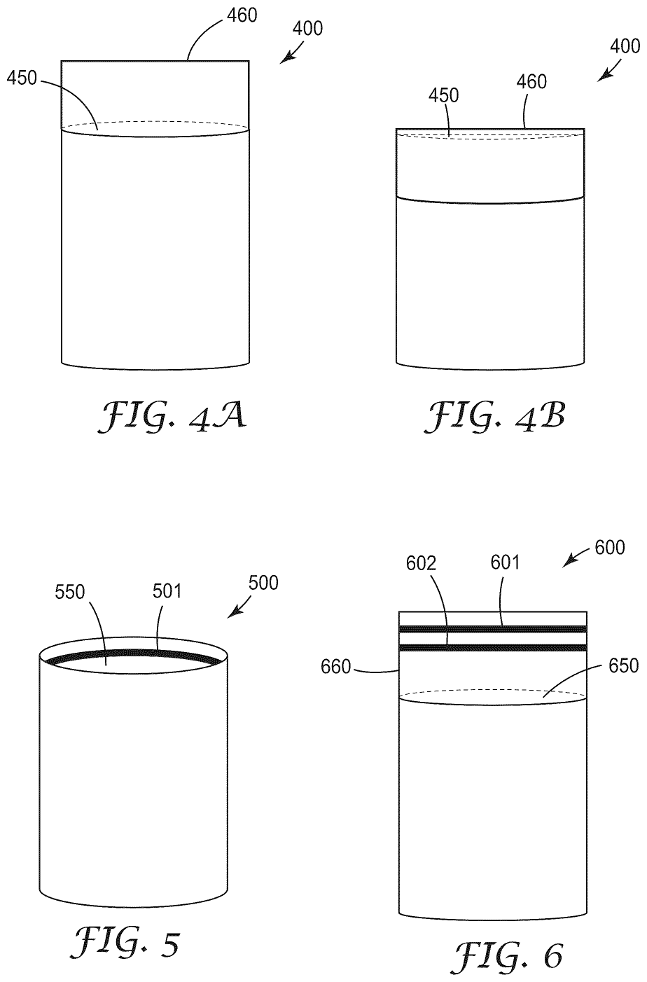

FIGS. 4A and 4B show another exemplary construction of packaging article 400, which contains flap 460, which is foldable between an open position, as shown in FIG. 4A, and a closed position as shown in FIG. 4B. In the open position, opening 450 is uncovered, but in a closed position, opening 450 is covered by flap 460.

Exemplary packaging article 500 with adhesive portion 501 is shown in FIG. 5. In this example, packaging article 500 is formed as a bag and adhesive portion 501 is disposed near the top of opening 550, to close opening 550 if desired.

Exemplary packaging article 600 with two adhesive portions 601 and 602 is shown in FIG. 6. In this example, packaging article 600 is formed as a pouch and adhesive portions 601 and 602 are disposed on flap 660 to close opening 650.

FIG. 7 shows an exemplary layered compostable article 700 according to the present application having a first surface 700a and a second surface 700b. The compostable article 700 includes a first compostable polymer layer 710, a second compostable polymer layer 720, and a third compostable polymer layer 730. In the example shown, the first compostable polymer layer 710 and the third compostable polymer layer 730 have the same composition. In some embodiments, these two compostable polymer layers comprise PBS and a hydrophobic agent. In some embodiments, the first and third compostable polymer layers were prepared by coating compostable compositions onto the second compostable polymer layer. In some embodiments, the second compostable polymer layer 720 has a different composition and/or a different presentation from the first and/or third compostable polymer layers (710, 730). In some embodiments, the second compostable polymer layer 720 includes PLA. In some embodiments, the PLA is spunbond. In other embodiments, the second compostable polymer layer 720 comprises a nonwoven web including PBS. Adhesive layer 740 is disposed on the first surface 700a of the compostable article 700. In some embodiments, a release layer 750 is disposed over the adhesive layer 740. In some embodiments, the release liner 750 comprises a silicone-coated polyester film.

FIG. 11 is a cross-section of an exemplary compostable article according to the present application. Compostable article 1100 includes a biodegradable polymer layer 1110 having a first surface 1120 and an opposite second surface 1130. In one embodiment, the biodegradable polymer layer 1110 includes a first compostable polymer and a hydrophobic agent. In some embodiments, the first compostable polymer is polybutylene succinate (PBS) and the hydrophobic agent is a compostable hydrophobic agent. In some embodiments, the biodegradable polymer layer 1110 includes a first biodegradable polymer and a second biodegradable polymer, wherein the first biodegradable polymer is different from the second biodegradable polymer. In the embodiment shown in FIG. 1, compostable article 1100 includes fibrous layer 1150 secured to biodegradable polymer layer 1110 by means of an adhesive 1140. Other embodiments do not include an adhesive. In some embodiments, the biodegradable polymer layer 1110 is extruded directly onto the fibrous layer 1150. In other embodiments, the biodegradable polymer layer 1110 and the fibrous layer 1150 are heat laminated.

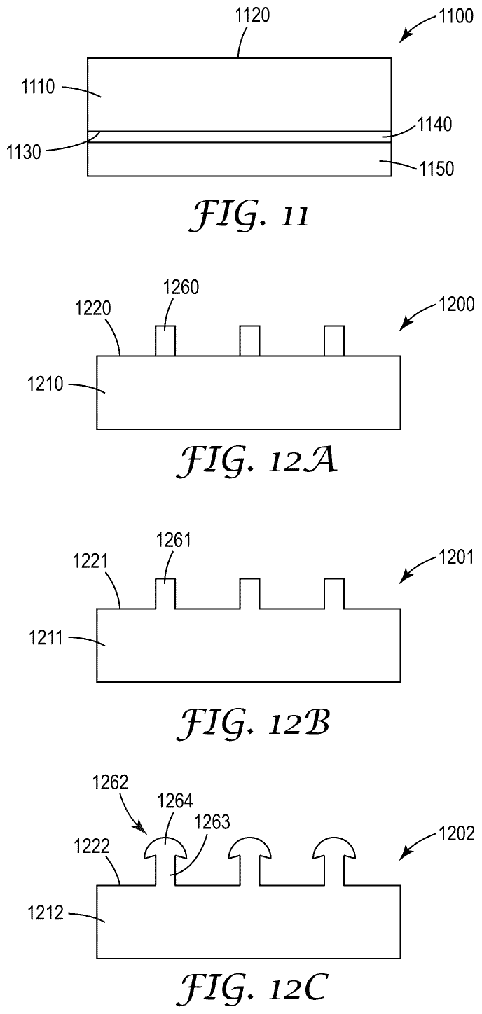

FIGS. 12a-12c are cross-sections of exemplary compostable articles according to the present application. The compostable article 1200 of FIG. 12a includes biodegradable polymer layer 1210 having a first surface 1220. Microstructures 1260 are disposed on the first surface 1220 of the compostable article 1200. In the compostable article 1201 of FIG. 12b, microstructures 1261 are projecting from the first surface 1221 and are integral with biodegradable polymer layer 1211. The microstructures 1262 of compostable article 1202 include a stem 1263 and a cap 1264. Stem 1263 is integral with cap 1264. In other embodiments (not shown), the stem is not integral with the cap.

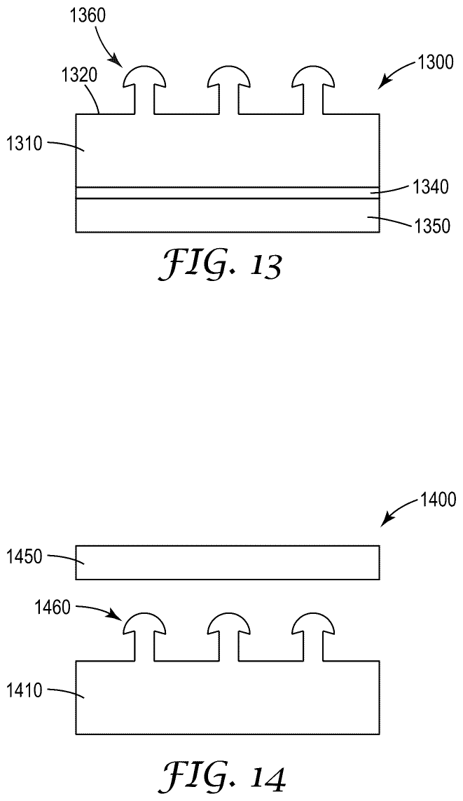

Compostable article 1300 shown in FIG. 13 includes a biodegradable polymer layer 1310 having microstructures 1360 extending from the first surface 1320 of the polymer layer 1310. Nonwoven layer 1350 is secured to the second surface of biodegradable polymer layer 1310 by means of an adhesive 1340.

In the compostable article 1400 shown in FIG. 14, nonwoven layer 1450 is adjacent microstructures 1460 which extend from biodegradable polymer layer 1410. In this embodiment, the nonwoven layer 1450 and microstructures 1460 form an attachment system. Exemplary uses of the attachment system shown in FIG. 14 include, personal hygiene items (e.g., feminine hygiene products, incontinence products, and diapers).

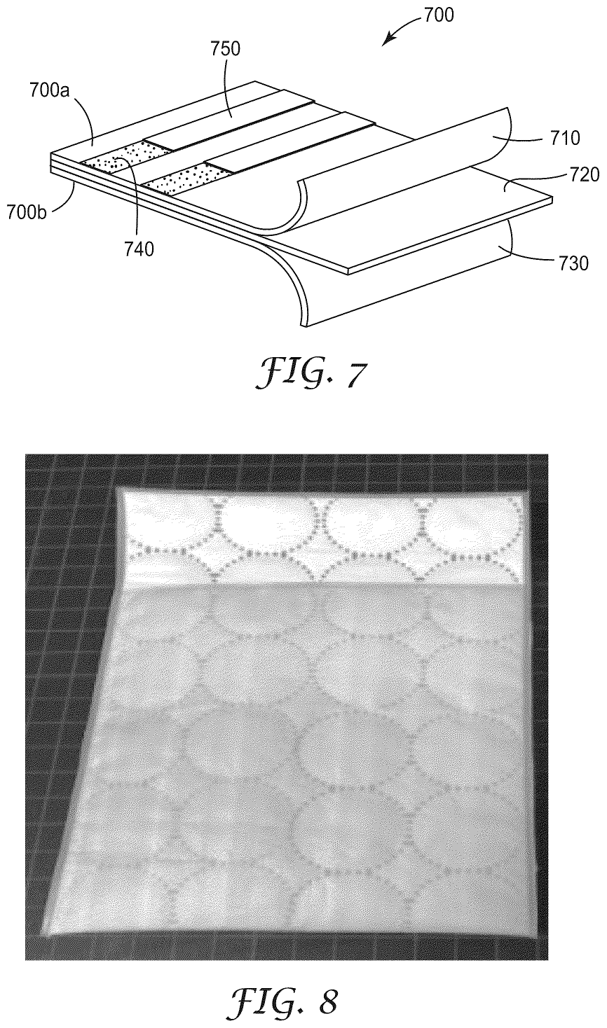

Diapers typically comprise a top sheet, a back sheet, and an absorbent core. The diaper further comprises a rear waistband, a front waistband section, and an intermediate crotch section, the fastening components being laterally applied to the rear waistband section. The fastening tab, in use, extends to and engages the corresponding opposing landing zone of the diaper to secure the diaper about the wearer. An exemplary diaper construction is shown on FIG. 8 of U.S. Pat. No. 10,413,457, the disclosure of which is incorporated herein in its entirety by reference. In some embodiments, the articles of the present disclosure may be used as packaging of feminine hygiene products. In some embodiments, these packaging are release liners that envelop and protect the feminine hygiene product prior to use. In other embodiments, the attachment systems of the present application may be used to secure release liners to the feminine hygiene products.

In order for materials to be considered hydrophobic and effective liquid barriers, they require a hydrophobicity indicated by advancing water contact angle measurements of at least 90°. In one aspect, the presently described compostable articles and compositions exhibit contact angle measurements with advancing water of at least 95°. In some embodiments, the present compostable compositions exhibit water contact angle measurements of 120°, 125°, and 135°. Another measure of a material's liquid barrier property is its water vapor transmission rate (WVTR), measured as described in ASTM F1249-13, “Standard Test Method for Water Vapor Transmission Rate Through Plastic Film and Sheeting Using a Modulated Infrared Sensor”.

### EXAMPLES

Advantages and embodiments of this invention are further illustrated by the following examples, but the particular materials and amounts thereof recited in these examples, as well as other conditions and details, should not be construed to unduly limit this invention. Foreseeable modifications and alterations of this disclosure will be apparent to those skilled in the art without departing from the scope and spirit of this invention. All parts and percentages are by weight unless otherwise indicated.

Unless otherwise noted, all parts, percentages, ratios, etc. in the Examples and the rest of the specification are by weight. The following abbreviations may be used: m=meters; cm=centimeters; mm=millimeters; um=micrometers; ft=feet; in=inch; RPM=revolutions per minute; g=grams; mg=milligrams; kg=kilograms; oz=ounces; lb=pounds; mL=milliliter; L=liter; Pa=Pascals; kPa=kilopascals; sec=seconds; min=minutes; hr=hours; psi=pounds per square inch; ° C.=degrees Celsius; ° F.=degrees Fahrenheit; and phr=parts (by weight) per hundred of resin. The terms “weight %”, “% by weight”, and “wt %” are used interchangeably.

### Materials

TABLE 1
Materials

| Abbreviation/Trade | |
|---|---|
| Designation | Description |
| BIOPBS FD92 | Polybutylene succinate, obtained from PTT MCC Biochem |
| (PBS 1) | Company Limited, Bangkok, Thailand |
| BIOPBS FZ71 | Polybutylene succinate, obtained from PTT MCC Biochem |
| (PBS 2) | Company Limited, Bangkok, Thailand |
| BIOPBS FZ91 | Polybutylene succinate, obtained from PTT MCC Biochem |
| (PBS 3) | Company Limited, Bangkok, Thailand |
| BIOPBS FD72 | Polybutylene succinate, obtained from PTT MCC Biochem |
| (PBS 4) | Company Limited, Bangkok, Thailand |
| INGEO 6252D | Polylactide, obtained from NatureWorks LLC, Minnentonka, MN |
| (PLA 1) | (USA) |
| INGEO 6202D | Polylactide, obtained from NatureWorks LLC, Minnentonka, MN |
| (PLA 2) | (USA) |
| CASTORWAX | Hydrogenated castor oil (castor wax), obtained from Vertellus, |
| | Indianapolis, IN (USA) |
| PLAM 69962 | PLA green masterbatch coloring, obtained from Techmer PM LLC, |
| | Clinton, TN (USA) |
| OM9364251 | PLA black masterbatch coloring obtained from Clariant Corporation |
| | Minneapolis MN (USA) |
| OM0364246 | PLA white masterbatch coloring obtained from Clariant Corporation |
| | Minneapolis MN (USA) |
| OMB8264260 | PLA brown masterbatch coloring obtained from Clariant |
| | Corporation Minneapolis MN (USA) |
| HM6422PI | Hot melt pressure sensitive adhesive obtained from Capital |
| | Adhesives, Mooresville, IN (USA) |
| PP701.2 | Metallized ¾″ (1.9 cm) Polypropylene film with silicone release |
| | coating obtained from Infinity Tapes, Lawrence, MA (USA) |
| Silicone Release | ¾″ (1.9 cm) Silicone PET Release Liner obtained from Rayven, |
| Liner | North St. Paul, MN (USA) |
| PPM56090 | PLA blue masterbatch coloring obtained from Techmer PM LLC, |
| | Clinton, TN (USA) |
| LUMINY L130 | Polylactide resin obtained from Total Corbion, The Netherlands |
| S-3575 | 30# Kraft paper obtained from Uline, Pleasant Prairie, WI, USA |
| ULTRATALC 609 | Hydrated magnesium silicate (median particle size of <0.9 μm), |
| (Talc) | obtained from Barretts Minerals Inc., Dillon, MT, USA |
| CRODAMIDE EBS | Ethylene-bis-stearamide, obtained from Croda International, plc, |
| (EBS) | Snaith, UK |
| #10 WHITE | Calcium carbonate, obtained from IMERYS Carbonates North |
| (CaCO₃ 1) | America, Roswell, GA, USA |
| HUBERCARB Q2 | Calcium carbonate, obtained from J. M. Huber Corporation, Edison, |
| (CaCO₃ 2) | NJ, USA |
| HUBERCARB Q2T | Calcium carbonate, surface treated, obtained from J. M. Huber |
| (CaCO₃ 3) | Corporation, Edison, NJ, USA |
| HUBERCARB Q3 | Calcium carbonate, obtained from J. M. Huber Corporation, Edison, |
| (CaCO₃ 4) | NJ, USA |
| HUBERCARB Q6 | Calcium carbonate, obtained from J. M. Huber Corporation, Edison, |
| (CaCO₃ 5) | NJ, USA |
| GLASS BUBBLES | Soda lime borosilicate glass, obtained from 3M Company, St. Paul, |
| IM16K | MN, USA |
| (GBs) | |

### Test Methods

### Percent Elongation, Stress at Break and Young's Modulus:

Exemplary and Comparative Compostable Compositions prepared as described below were injection molded using an Engel 100 TL Ton press to make a “dog bone” specimen and tested. The thin portion of the specimen had measurements of 0.125 inches (3.1 mm) in thickness, 2.50 inches (12.7 mm) in length and 0.50 inches (12.7 mm) in width. Test specimens were weathered at 120° F. (49° C.) and 65% relative humidity for two weeks and equilibrated at 73.1° F. (22.8° C.) and 50% relative humidity for at least 12 hours prior to testing. An Electromechanical Universal Test Systems (obtained under the trade designation “MTS CRITERION MODEL 43” from MTS Systems Corporation, Eden Prairie, MN, USA) was used to measure the tensile properties of the specimens at a constant rate of extension. The load frame was equipped with a 10 kN load cell and mechanical wedge grips (obtained under the trade designation “MTS ADVANTAGE” part number 056-079-501 from MTS Systems Corporation, Eden Prairie, MN, USA) were used to secure the specimen. The gap between grips was adjusted to 2.5 inch (63.5 mm) and test rate was performed at 0.2 inch/min. The load cell was zeroed with no test specimen in the grips prior to each reading. The load cell ceases vertical movement once the specimen breaks in the testing field. A thickness gauge was used to record the specimen's actual thickness in the center of the sample prior to testing. The room in which the testing was performed was temperature controlled to 73.1±2° F. and 50±2% RH. For each test, the following was reported: %-elongation, Stress at Break (“psi”) and the Young's Modulus (“ksi”). The Young's Modulus was calculated as the ratio of the stress to strain in the initial linear region of the stress-strain curve.

### Other Test Methods:

Additional test methods that were used to characterize the exemplary articles are summarized in Table 2, below. For coefficient of friction testing, the side of the sample forming the outside of the pouch as described in the preparation procedures was tested against a steel surface. For tensile properties, sample widths were 0.5 in (1.2 cm) for non-padded materials, and 1 in (2.5 cm) for padded materials. Samples were conditioned in a controlled temperature and humidity room overnight, and a pull speed of 10 in/min (25 cm/min) was used. Samples were tested in both the machine direction (MD) and the cross-web (transverse) direction (CD). Slip was determined as the average force reading during uniform sliding of the surfaces, and the kinetic coefficient of friction was calculated as the slip divided by the sled weight (200 g).

TABLE 2
Test Methods

| Property | Test Method |
|---|---|
| Gauge/Nominal | ASTM D-2103-15, “Standard Specification for Polyethylene |
| Thickness | Film and Sheeting” |
| Slip | ASTM D-1894-14, “Standard Test Method for Static and |
| | Kinetic Coefficients of Friction of Plastic Film and |
| | Sheeting” |
| Kinetic Coefficient of | ASTM D-1894-14, “Standard Test Method for Static and |
| Friction | Kinetic Coefficients of Friction of Plastic Film and |
| | Sheeting” |
| Tensile Strength and | ASTM D-882-18, “Test Method for Tensile Properties of |
| Ultimate Load | Thin Plastic Sheeting” |
| Elongation at Break | ASTM D-882-18, “Test Method for Tensile Properties of |
| | Thin Plastic Sheeting” |
| 1% Secant Modulus | ASTM D-882-18, “Test Method for Tensile Properties of |
| | Thin Plastic Sheeting” |
| Elmendorf Tear | ASTM D-1922-15, “Test Method for Propagation Tear |
| Resistance | Resistance of Plastic Film and Thin Sheeting by Pendulum |
| | Method” |
| Impact Resistance | ASTM D-1709-16a, “Test Methods for Impact Resistance of |
| | Plastic Film by the Free-Falling Dart Method” (Method A) |
| Advancing Water | ASTM D5725-99 (2008), “Standard Test Method for |
| Contact Angle | Surface Wettability and Absorbency of Sheeted Materials |
| | Using an Automated Contact Angle Tester” |
| Water Vapor | ASTM F1249-13, at a temperature of 23° C. with 100% |
| Transmission Rate | relative humidity. Results are reported in g/(m2 · day). |
| (WVTR) | |

### Compostable Films and Pouches Examples

Preparation of Compostable Films and Pouches of Examples 1-26 is described below.

### PLA Web Production

Non-woven fibrous layers were made from INGEO Biopolymer 6202D according to the following procedure: the multi-layered composites in all examples were prepared following the general method disclosed in U.S. Pat. No. 3,802,817, the disclosure of which is incorporated herein by reference in its entirety. Specifically, the apparatus that was used to form the spunbond webs includes a first station and a second station, with the first station used to create the first nonwoven layer and the second station used to create the second nonwoven layer. Each station includes at least an extrusion head an attenuator and a quenching stream, with both stations sharing a collector surface. The first station is positioned upstream from the second station, resulting in filaments produced at the first station reaching the collector surface first and forming a first mass of fibers on the collector surface. Filaments from the second station are thus deposited on the surface of the first fiber mass and form a second mass of fibers thereon.

The fiber-forming material is melted in an extruder and pumped into the extrusion heads, which include multiple orifices arranged in a regular pattern, e.g., straight line rows. Filaments of fiber-forming liquid are extruded from the extrusion head and may be conveyed through air-filled space to an attenuator. Filaments are deliberately depicted as in a core/sheath configuration. This configuration persists even if the core and sheath are made of the same material, as a boundary exists between the two layers (core and sheath) of the material. Quenching streams of air are directed toward extruded filaments; the air may to reduce the temperature of, or partially solidify, the extruded filaments.

The filaments pass through the attenuator and then are deposited onto a generally flat collector surface where they are collected as a first mass of fibers. The filaments passing through the attenuator are deposited onto the surface of the first fiber mass or web.

The collector is generally porous and gas-withdrawal (vacuum) device is positioned below the collector to assist deposition of fibers onto the collector (porosity, e.g., relatively small-scale porosity, of the collector does not change the fact that the collector is generally flat as defined above).

With regard to the apparatus described above, the fibrous layers are made as follows. In Step 1, PLA/PLA (all PLA used was obtained under the trade designation INGEO Biopolymer 6202D) sheath/core filaments are extruded at a temperature of 200° C. to 230° C. (sheath) and 230° C. (core), then drawn by quench air at 10° C. and the flowrates of 23 m³/min in Zone 1 and 23 m³/min in Zone 2, to form a PLA/PLA spunbond first composite layer. PLA monocomponent filaments are extruded at 230° C., then drawn by a quench air at 15° C. and the flowrate of 12 m³/min, to lay on the first composite layer to form a dual-layer web. The dual-layer web then passed through a through-air bonding station (i.e., were autogenously bonded), where a hot air of 100° C.-125° C.-130° C. was blown on the dual-layer web to thermally bond the dual-layer web. Web speed was adjusted as needed to obtain the desired basis weight. Lower basis weights are obtained with faster web speeds; higher basis weights are obtained with higher web speeds.

PLA webs having the following basis weights were produced using the apparatus and procedure described above:
Preparatory Example 1a: basis weight 25 g/m²
Preparatory Example 1b: basis weight 45 g/m²
Preparatory Example 1c: basis weight 80 g/m²
Preparatory Example 1d: basis weight 30 g/m²

### Web Coating Process

The webs were coated by melt extrusion of the coating material using a 58-millimeter (mm) twin screw extruder (obtained under the trade designation “DTEX58” from Davis-Standard, Pawcatuck, CT, USA), operated at a 260° C. extrusion temperature, with a heated hose (260° C.) leading to a 760 mm drop die (obtained from Cloeren, Orange, TX, USA) with 686 mm deckles: 0-1 mm adjustable die lip, single layer feed-block system. Solid coating material was fed at a rate of 50 pounds per hour (22.7 kg/hr) into the twin-screw system at the conditions described above. The resultant molten resin formed a thin sheet as it exited the die and was cast onto the web. The surface roughness was set at 75 Roughness Average by use of a sleeve (American Roller, Union Grove, WI, USA) against the cast film side, and a silicone rubber nip roll (80-85 durometer; from American Roller) was against the spunbond side. The layered composite was pressed between the two nip rolls with a nip force of about 70 KPa, at a line speed that was adjusted to provide the desired coating thickness.

### Preparation of Examples 2-25

### Example 2

A 900 m length of web from Preparatory Example 1a was coated on the bottom with BIOPBS FD72 to a coating thickness of 25 μm. The web was cut in half; one half (450 m length) is the product of this example and the other half was used in Example 5.

### Example 3

A 900 m length of web from Preparatory Example 1b was coated on the bottom with BIOPBS FD72 to a coating thickness of 25 μm. The web was cut in half; one half (450 m length) is the product of this example and the other half was used in Example 6.

### Example 4

A 900 m length of web from Preparatory Example 1c was coated on the bottom by with BIOPBS FD72. The web was cut in half; one half (450 m length) is the product of this example and the other half was used in Example 7.

### Example 5

The web from Example 2 was cut in half (two 450 m lengths). The top of one of the halves was coated with 99.5% BIOPBS FZ71 and 0.5% PLAM 69962 using a nip roll set for matte finish. The coating thickness was 25 μm.

### Example 6

The web from Example 3 was cut in half (two 450 m lengths). The top of one of the halves was coated with BIOPBS FZ71 with 0.5% PLAM 69962 using a nip roll set for matte finish. The coating thickness was 25 μm.

### Example 7

The web from Example 4 was cut in half (two 450 m lengths). The top of one of the halves was coated with BIOPBS FZ71 with 0.5% PLAM 69962 using a nip roll set for matte finish. The coating thickness was 25 μm.

### Example 8

The top of a web prepared according to Preparatory Example 1b was coated with a composition of 80% BIOPBS FZ71, 0.5% PLAM 69962, and 19.5% of a mixture of 95% BIOPBS FZ71 with 5% CASTORWAX.

### Example 9

The top of a web prepared according to Example 2 was coated with a composition of 80% BIOPBS FZ71, 0.5% PLAM 69962, and 19.5% of a mixture of 95% BIOPBS FZ71 with 5% CASTORWAX.

### Example 10

PBS 2-sided coated 40 #Kraft paper (Uline) was produced using conventional extrusion coating line. The topcoat had the composition of 80% BIOPBS FZ71, 0.5% PLAM 69962, and 19.5% of a mixture of 95% BIOPBS FZ71 with 5% CASTORWAX. The bottom coat has BIOPBS FD72 to a coating thickness of 25 μm.

### Example 11

A web of Preparatory Example 1d was coated on both sides by melt extrusion of the coating material using the web coating procedures described above, except that the solid coating material was fed at a rate of 200 pounds per hour (90.7 kg/hr) into the twin-screw system at the conditions provided.

The coating on the top side was a composition of 99% BIOPBS FZ71 and 1% PLAM 69962 at to a coating thickness of 75 micrometers (μm), and the coating on the bottom side was a composition of 95% PBS FD72, 4% OM0364246, and 1% OM9364251 to a coating thickness of 75 μm.

The web was made into pouches using an automatic wicket bag machine model M2106WASP-25 (Hudson-Sharp, Green Bay, WI, USA). The machine folded the web with the two bottom coated layers facing each other such that the bottom coated layers became the inside of the pouches. The web was folded approximately 15.2 cm (6 inches) from the center line, leaving a flap of about 15.2 cm (6 inches).

Two strips (approx. 19.05 mm or 0.75 inch) of hot melt pressure sensitive adhesive HM6422PI were extruded on the flap, and PP701.2 metallized release liner was fixed on top of one strip of the hot melt PSA and PET release liner was fixed on top of the other strip of the hot melt PSA. Individual pouches were then formed by use of a hot knife slitting operation to cut and seal the side edges.

### Example 12

Example 12 was the same as Example 11 except for the following differences:

During the web coating process, the solid coating material was fed at a rate of 50 pounds per hour (22.7 kg/hr) into the twin-screw system.

The thickness of both the top side and bottom side coatings was 37 μm. The compositions of both coatings were identical to the corresponding coatings used in Example 11.

### Examples 13A and 13B

A first PLA web was prepared and coated as in Example 12. A second PLA web was prepared as follows. A masterbatch of 95% BIOPBS FZ71 and 5% CASTORWAX was used as a melted polymer flowing through a plurality of orifices. A staple fiber was produced according to the method described in WO1999051799 using 95% BIOPBS FZ91 with 5% hydrogenated castor oil as the sheath, LUMINY L130 as the core, 3 denier, 31 mm. The fiber was directed at a perpendicular angle to the stream of molten filaments (fibers) and collected as a nonwoven fibrous layer.

The first PLA web was stacked on top of the second PLA web, with the bottom side of the first PLA web contacting the second PLA web. The two webs were then sealed together by ultrasonic welding using a Branson AED machine equipped with an 11.4 cm×15.2 cm (4.5″×6″) aluminum block horn and booster of 1:1.5. The weld method was Energy. The weld value was 700 J, at a pressure of 552 kPa (80 psi) for a 7.62 cm (3 inch) circle. Amplitude was set to 100%, trigger to 45.4 kg (100 lbs), and the hold time was 1 second.

In Example 13A the anvil contained six cavities of 38 mm (1.5 inch) circular dot pattern, with 36 dots (each of 1.5 mm (0.061 inch)) per circle. In Example 13B the anvil was a nested hexagonal pattern. The hexagons were nested hexagonal pattern, 20 mm from one corner to an opposing corner, had a 1 mm thick wall, and were spaced 5 mm apart. Pouches of Examples 13A and 13B were formed by use of a manual impulse sealer, model H-458 (Uline, Pleasant Prairie, WI, USA). The web was folded away from the center line to leave a flap, with the second PLA web facing the inside. The edges were heat sealed by the impulse sealer and cut to create the final pouches.

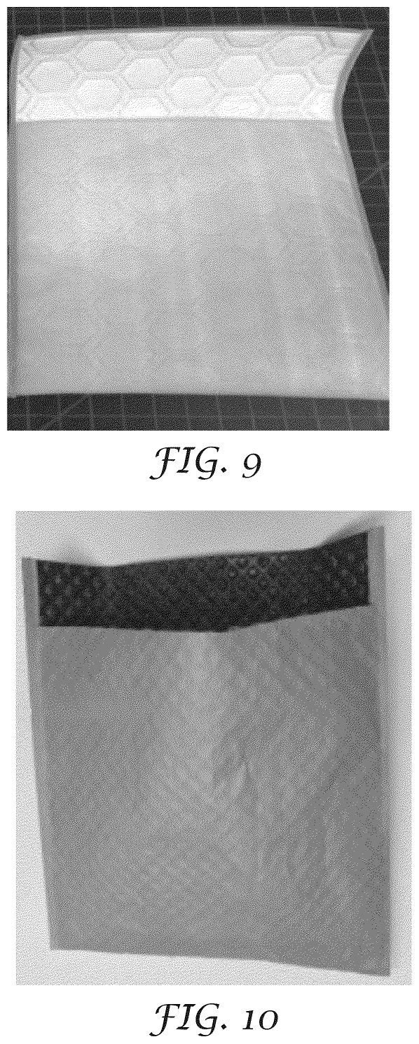

FIG. 8 is a photograph of Example 13A (circular dot pattern). FIG. 9 is a photograph of Example 13B (hexagonal pattern).

### Examples 14A and 14B

Examples 14A and 14B are similar to Examples 13A and 13B, respectively, except that a third spunbond PLA web (preparatory Example 1d) was placed between the first and second PLA webs of Examples 13A and 13B before the ultrasonic welding step.

### Example 15

A PLA web was prepared as described for the second PLA web in Examples 13A and 13B. Two pieces of 30 #Kraft paper were heat laminated on one side to a 20 μm thick coating BIOPBS FD92. The PLA web was placed between the two pieces of Kraft paper such that the coating on the Kraft paper faced the PLA web.

Pouches were manufactured by the ultrasonic welding and impulse sealing method of Example 13A.

### Example 16

A spun bond first PLA web (Preparatory Example 1a) was coated on the top side with a mixture of 99% BIOPBS FZ71 and 1% PLAM 69962 to a thickness of 37 μm and on the bottom side with BIOPBS FZ71 to a thickness of 37 μm, using the web coating procedures provided above. The coated PLA web was then embossed using the method described in U.S. Pat. No. 5,256,231, in which a 35.6 (14 inch) wide web was fed into a diamond patterned tool to form a 3D structure.

A second smooth PLA web, which was identical to the embossed first PLA web layer except that it was not embossed, was then heat laminated to the embossed coated web to form a two-layer web. The webs were laminated so that the top side of the embossed PLA web was laminated to the bottom side of the smooth PLA web.

The two-layer web was converted into a pouch using the impulse sealing method as described in Example 13A, with the embossed PLA web on the inside of the mailer and the smooth PLA web on the outside of the mailer.

### Example 17

An embossed PLA web was made as described in Example 16. The embossed PLA web was heat laminated to a layer of 30 #Kraft Paper Style S-3575 so that the top side of the PLA web contacted the Kraft Paper. The resulting material was made into pouches by the impulse sealing method described for Examples 13A and 13B, with the embossed PLA web on the inside of the pouch and the Kraft paper on the outside of the pouch.

### Example 18

30 #Kraft Paper was coated on one size with BIOPBS FZ71 to a thickness of 25 μm. The coated Kraft paper was embossed according to the process described in Example 16. The coated Kraft paper was then heat laminated to another uncoated 30 #Kraft paper so that the coated layer of the coated Kraft paper contacted the uncoated Kraft paper to form a two-layer material. The two-layer material was made into pouches using the impulse sealing method described in Example 13A.

### Example 19

A spun bond PLA fibrous layer (Preparatory Example 1a) was coated on the top with a composition of 98% BIOPBS FZ71, 0.7% OMB8264260, and 1.3% OM0364246 to a thickness of 25 μm and on the bottom with 98% BIOPBS FZ71, 1% OM0364246, and 1% OM9364251 to a thickness of 25 μm, using the web coating procedures provided above. The web was converted into pouches using the process as described in Example 11, including the placement of PSA and release liners on the flap.

### Example 20

A spun bond PLA fibrous layer (Preparatory Example 1b) was coated and converted into pouches by the methods described in Example 19.

### Example 21

A spun bond PLA fibrous layer having a basis weight of 45 g/m² was made according to the method of Example 19, except that the web was made out of a mixture of 98.5% INGEO 602D and 1.5% PPM56090. The web was coated and converted into pouches by the methods described in Example 19.

### Example 22

A first PLA web of Preparatory Example 1a was coated using the web coating procedures described above: the top side was coated with a mixture of 90% BIOPBS FZ71 and 10% PLAM 69962 to a thickness of 37 μm, and the bottom side was coated with a mixture of 90% BIOPBS FZ71 and 5% OM0364246 and 5% OM9364251 to a thickness of 37 μm.

The first coated PLA web was then embossed using the method described in U.S. Pat. No. 5,256,231, in which a 35.6 (14 inch) wide web was fed into a diamond patterned tool to form a 3D structure.

A second PLA web, which was identical to the embossed first PLA layer except that it was not embossed, was then heat laminated to the embossed coated web to form a two-layer web. The webs were laminated so that the top side of the embossed PLA web was laminated to the bottom side of the smooth PLA web.

The two-layer web was converted into a pouch using the impulse sealing method as described in Example 13A, with the embossed PLA web on the inside of the mailer and the smooth PLA web on the outside of the mailer.

### Example 23

An embossed PLA web was made according to Example 22, then the web was heat laminated to a layer of 30 #Kraft Paper Style S-3575 so that the top side of the PLA web contacted the Kraft Paper. The resulting material was made into pouches by the impulse sealing method described in Example 13A, with the embossed PLA web on the inside of the pouch and the Kraft paper on the outside of the pouch.

FIG. 10 is a photograph of the pouch of this example.

### Example 24

For Example 24A, a spun bond PLA fibrous layer (Preparatory Example 1a) was coated on the top with a composition of 98% BIOPBS FZ71, 0.7% OMB8264260, and 1.3% OM0364246 to a thickness of 25 μm and on the bottom with 98% BIOPBS FZ71, 1% OM0364246, and 1% OM9364251 to a thickness of 25 μm, using the web coating procedures above. A flat tube was made by folding the material and sealing the edge continuously using a SEAMMASTER LM920 Ultrasonic Welder (SONOBOND, West Chester, PA, US) using a 2-inch (5.0 cm) horn, 1:1.5 booster, 50% amplitude, 3 row stitch patterns, 50 psi (345 kPa), a 0.75 inch (1.9 cm) diameter cylinder, and a speed of 15 ft/min (4.6 m/min). For Example 24B, an embossed PLA web was prepared as described for Example 22, and a tube was made using the same continuous ultrasonic method used for Example 24A.

Rolled tubes of Examples 24A and 24B were fed into a ROLLBAG 3200 bagging machine (PAC Machinery, San Rafael, CA, US) to make flat (24A) and padded (24B) packaging articles.

### Example 25

For Example 25A, a spun bond PLA fibrous layer (Preparatory Example 1b) was coated on the top with a composition of 98% BIOPBS FZ71, 0.7% OMB8264260, and 1.3% OM0364246 to a thickness of 25 μm and on the bottom with 98% BIOPBS FZ71, 1% OM0364246, and 1% OM9364251 to a thickness of 25 μm, using the web coating procedures above. For Example 25B, an embossed PLA web was prepared as described for Example 22.

Individual flat (Example 25A) and padded (Example 25B) packaging pouches were made by folding each material and sealing the side edges by ultrasonic plunge welding using a Branson AED Ultrasonic Welder (Emerson Automation Solutions, St. Louis, MN, US) with a 14″×0.25″ (36 cm×0.64 cm) titanium horn, 1:1.5 booster, 75% amplitude, an anvil with a 14″×0.25″ (36 cm×0.64 cm) knurl pattern, a 250 lb (113 kg) trigger, a pressure of 60 psi (414 kPa) over a 3 inch (7.6 cm) diameter cylinder, and a hold time of 0.30 seconds.

### Example 26

Flat and padded pouches were made as described for Examples 25A and 25B. One strip (approx. 19.05 mm or 0.75 inch) of hot melt pressure sensitive adhesive. The adhesive was extruded on a silicone-coated paper release liner, then slit to make adhesive strips. A strip was fixed on top of the flap of the flat mailer and on the lip of the padded mailer.

Packaging articles prepared as described in Examples 1-26 were tested using the test methods listed above. Results are reported in Table 3, below.

TABLE 3
Results

| Property | Ex. 12 | Ex. 14B | Ex. 20 | Ex. 22 | Ex. 23 |
|---|---|---|---|---|---|
| Gauge, mm | 0.18 | 1.4 | 0.27 | 1.65 | 0.10 |
| Slip, g | 56 | 50 | 46 | 41.4 | 43 |
| Kinetic Coefficient of Friction | 0.282 | 0.250 | 0.231 | 0.207 | 0.215 |
| Tensile Strength-MD, MPa | 14.5 | 3.2 | 10.7 | 2.5 | 6.9 |
| Tensile Strength-CD, MPa | 8.0 | 1.8 | 6.3 | 1.3 | 2.9 |
| Elongation at Break-MD (%) | 22.6 | 25 | 22.3 | 17 | 2 |
| Elongation at Break-CD (%) | 17.1 | 17 | 8.4 | 8 | 3 |
| 1% Secant Modulus-MD, MPa | 439 | — | 334 | — | — |
| 1% Secant Modulus-CD, MPa | 229 | — | 208 | — | — |
| Elmendorf Tear-MD, g | 158 | did not tear | 427 | 337 | 262 |
| Elmendorf Tear-CD, g | 386 | did not tear | 551 | 578 | 288 |
| Impact Resistance, g | 150 | — | 276 | 72 | 50 |

### Comparative and Compostable Composition Examples

Compostable Compositions of Examples I through XIII and Comparative Compositions CI through CIII were prepared as described below.

Polybutylene succinate (“PBS”) and polylactic acid (“PLA”) resins were dried in a mobile desiccant dryer system (obtained under the trade designation “Model MDCW015” from Conair Group, Inc., Abbotsford, Canada) at a temperature of 170 ºF (77° C.) for a minimum of 4 hours and a maximum of 12 hours prior to processing to remove residual moisture. Materials were metered at the weight percent (“wt. %”) ratios for each Example as shown in Table 4. A 30 mm twin screw extruder (“TSE”) with an L/D ratio of 30 (obtained under the trade designation “MP2030” from APV, now a part of Baker Perkins, Inc., Grand Rapids, MI, USA) was used to compound the materials as follows. The PBS and PLA were metered into the feed throat of the TSE using gravimetric screw feeders (obtained under the trade designation “K-TRON T20” from Coperion, GmbH, Stuttgart, Germany) at desired ratios. A side stuffer feeder (obtained under the trade designation “K-TRON T20” from Coperion, GmbH, Stuttgart, Germany) was utilized in zone 6 of the TSE, at approximately 18 L/D, where a hydrophobic agent (e.g., CASTORWAX, EBS) and/or a filler (i.e., a talc, a CaCO₃) were introduced when used. When a hydrophobic agent and an inorganic filler were used, they were preblended at a desired ratio prior to addition to the polymeric feed. These material blends were metered using a gravimetric screw feeder (obtained under the trade designation “K-TRON T20” from Coperion, GmbH, Stuttgart, Germany). At the discharge end of the TSE, a single hole strand die was used to extrude the output melt. Processing steel temperatures were ambient (e.g., 20-25° C.) in zone 1, 300° F. (149° C.) in zone 2, and 350° F. (177° C.) from zone 3 to the die. Throughput was 15 lbs/hr (6.8 kg/hr) total at a screw speed of 250 RPM. The extrudate from the TSE for each Example was pulled via a knurled nip roll through a 6 ft. (1.8 m) water bath cooled to 55° F. (13° C.) and pelletized using a rotary cutting blade.

TABLE 4
Compositions of Examples I-XIII and Comparative Compositions CI-CIII

| | PBS | PBS | PLA | PLA | | Filler | | Wax |
|---|---|---|---|---|---|---|---|---|
| Ex. | Grade | wt. % | Grade | wt. % | Filler | wt. % | Wax | wt. % |
| I | PBS 2 | 95 | — | 0 | — | 0 | CASTORWAX | 5 |
| II | PBS 3 | 95 | — | 0 | — | 0 | CASTORWAX | 5 |
| III | PBS 4 | 35 | PLA 2 | 30 | Talc | 32.5 | CASTORWAX | 2.5 |
| IV | PBS 4 | 30 | PLA 2 | 30 | Talc | 37.5 | CASTORWAX | 2.5 |
| V | PBS 4 | 20 | PLA 2 | 25 | Talc | 52.5 | CASTORWAX | 2.5 |
| VI | PBS 1 | 30 | PLA 2 | 30 | CaCO₃ 1 | 35 | EBS | 5 |
| VII | PBS 4 | 46 | PLA 1 | 46 | GBs | 5 | CASTORWAX | 3 |
| VIII | PBS 4 | 41 | PLA 1 | 41 | GBs | 15 | CASTORWAX | 3 |
| IX | PBS 4 | 36 | PLA 1 | 36 | GBs | 25 | CASTORWAX | 3 |
| X | PBS 4 | 30 | PLA 1 | 30 | CaCO₃ 2 | 37.5 | CASTORWAX | 2.5 |
| XI | PBS 4 | 30 | PLA 1 | 30 | CaCO₃ 3 | 37.5 | CASTORWAX | 2.5 |
| XII | PBS 4 | 30 | PLA 1 | 30 | CaCO₃ 4 | 37.5 | CASTORWAX | 2.5 |
| XIII | PBS 4 | 30 | PLA 1 | 30 | CaCO₃ 5 | 37.5 | CASTORWAX | 2.5 |
| CI | PBS 2 | 100 | — | 0 | — | 0 | — | 0 |
| CII | PBS 1 | 30 | PLA 2 | 30 | Talc | 40 | — | 0 |
| CIII | PBS 1 | 30 | PLA 2 | 30 | CaCO₃ 1 | 40 | — | 0 |

Mechanical properties of Compostable Composition Examples I-XIII and Comparative Compositions CI-CIII were tested as described above. Results are reported in Table 5, below.

TABLE 5
Mechanical Testing Results

| | Biodegradable | Filler | Modulus | Elongation | Break Stress |
|---|---|---|---|---|---|
| Examples | polymer | (Y/N) | ksi (MPa) | at Break (%) | PSI (MPa) |
| I | PBS | N | 93.1 (641.9) | 19.4 | 4936.0 (34.0) |
| II | PBS | N | 86.3 (595.0) | 26.6 | 4956.3 (34.2) |
| III | PBS/PLA | Y | 458.3 (3159.9) | 2.4 | 4354.0 (30.0) |
| IV | PBS/PLA | Y | 487.7 (3362.6) | 2.1 | 4364.4 (30.1) |
| V | PBS/PLA | Y | 639.8 (4411.3) | 1.0 | 3530.8 (24.3) |
| VI | PBS/PLA | Y | 289.6 (1996.7) | 1.1 | 2036.4 (14.0) |
| VII | PBS/PLA | Y | 180.4 (1243.8) | 12.6 | 5271.8 (36.4) |
| VIII | PBS/PLA | Y | 171.4 (1181.8) | 3.9 | 4936.0 (34.0) |
| IX | PBS/PLA | Y | 211.9 (1461.0) | 2.2 | 4956.3 (34.2) |
| X | PBS/PLA | Y | 203.7 (1404.5) | 5.7 | 3359.1 (23.2) |
| XI | PBS/PLA | Y | 188.0 (1296.2) | 5.3 | 3241.3 (22.3) |
| XII | PBS/PLA | Y | 204.8 (1412.0) | 7.0 | 3105.6 (21.4) |
| XIII | PBS/PLA | Y | 206.0 (1420.3) | 6.5 | 3096.7 (21.4) |
| CI | PBS | N | 91.3 (629.5) | 17.7 | 5271.8 (36.4) |
| CII | PBS/PLA | Y | 488.5 (3368.1) | 1.5 | 3641.0 (25.1) |
| CIII | PBS/PLA | Y | 298.1 (2055.3) | 1.1 | 2239.4 (15.4) |

### Compostable Article Examples

### Comparative Example A (CEA)

Comparative Example A was prepared using a 58-millimeter (mm) twin-screw extruder (obtained under the trade designation “DTEX58” from Davis-Standard, Pawcatuck, CT), operated at a 260° C. extrusion temperature, with a heated hose (260° C.) leading to a 760 mm drop die (obtained from Cloeren, Orange, TX) with 686 mm deckles: 0-1 mm adjustable die lip, single layer feed-block system. Polybutylene succinate (BioPBS FZ71) resin was fed at a rate of 50 pounds per hour (22.7 kilograms per hour) into the twin-screw system at the conditions described above. The resultant molten resin formed a thin sheet as it exited the die and was cast into a nip assembly consisting of a plasma coated casting roll (75 roughness average; obtained from American Roller, Union Grove, WI) and a silicon rubber nip roll (80-85 durometer; from American Roller). The cast film was pressed between the two nip rolls with a nip force of about 70 Kilopascals (KPa), at a line speed of 23 meters per minute. and eventually wound on a 3-inch cardboard core. The film of Comparative Example A had a thickness of 50-75 microns.

### Comparative Example B (CE B)

Comparative Example B was prepared by imparting microstructures having stems and caps to the film of Comparative Example A. The molten PBS thin sheet was cast onto a rotating mold having cavities, as generally described in the Example of U.S. Pat. No. 5,679,302, the disclosure of which is incorporated herein by reference in its entirety. The density of the microstructures was 2200 microstructures/inch² (341 microstructures/cm²). The height of each microstructure was 10 mils (0.25 mm) and the web backing thickness was 3.2 mils (80 microns). The caps were generally round and had a diameter of about 0.27 mm. The microstructured film was solidified and stripped off the mold as a web having an array of upstanding microstructures according to the cavity dimensions.

### Comparative Example C (CE C)

A food saver bag, obtained under the trade designation “ZIPLOC”, was cut into 3 inch by 3 inch square of material with the outward facing side of the film used for testing. This material is hereinafter referred to as Comparative Example C.

### Comparative Example D (CE D)

A white Teflon tape was obtained under the trade designation “ITEM #21TF19” with the description of “½″W PTFE THREAD SAMPLE TAPE, WHITE, 260″ LENGTH” from Grainger, Lake Forest, IL. This material is hereinafter referred to as Comparative Example D.

### Example E (EX1)

Example E was prepared as described in Comparative Example A, with the exception that 1 wt % of CASTORWAX was mixed with BioPBS FZ71 resin prior to extrusion.

### Example F (EX2)

Example F was prepared as described in Example E, with the exception that microstructures were additionally imparted on the film following the method described in Comparative Example B.

Advancing Water Contact Angle Measurements and Water Vapor Transmission Rate Values were obtained following the test methods described above. Results are reported in Table 6 below.

TABLE 6
Advancing Water Contact Angle Measurements
and Water Vapor Transmission Rate Values

| | Advancing Water Contact | WVTR |
|---|---|---|
| Examples | Angle (Degrees) | g/(m² · day) |
| CE A | 68.5 | Not measured |
| CE B | 67.4 | Not measured |
| CE C | 97.0 | Not measured |
| CE D | 107.0 | Not measured |
| EX E | 125.0 | 35.4 |
| EX F | 135.0 | Not measured |

Examples according to the present disclosure exhibited surprisingly high advancing water contact angles, which made them effective liquid barriers, or moisture and weather resistant. As such, compostable compositions according to the present disclosure are useful in applications such as in, for example, packaging and personal hygiene items.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

What is claimed is:

1. A packaging article comprising
a first wall having a first interior surface and a first exterior surface opposite the first interior surface;
a second wall having a second interior surface and a second exterior surface opposite the second interior surface, the first and second interior surfaces defining an interior of the packaging article and the first and second exterior surfaces defining an exterior of the packaging article; and
one or more edges where the first wall is attached to the second wall;
wherein the first wall or the second wall comprises a compostable composition comprising:
a first biodegradable polymer selected from the group consisting of poly(ethylene succinate) (PES), poly(trimethylene succinate) (PTS), poly(butylene succinate) (PBS), poly(butylene succinate co-butylene adipate) (PBSA), poly (butylene adipate coterephthalate) (PBAT), poly(tetramethylene adipate-co-terephthalate) (PTAT);
thermoplastic starch; and
a hydrophobic agent.

2. The packaging article of claim 1, wherein the article is one of a pouch, a bag, or an envelope.

3. The packaging article of claim 1, wherein the compostable composition is a heatsealable compostable coating.

4. The packaging article of claim 3, wherein the compostable heat-sealable coating comprises one or more of polybutylene succinate, poly (butylene succinate adipate), poly(ethylene succinate), poly(tetramethylene adipate-co-terephthalate), or thermoplastic starch.

5. The packaging article of claim 3, wherein at least one of the first wall or the second wall comprises a polylactide coated with the heat-sealable coating.

6. The packaging article of claim 1, wherein at least one of the first wall and the second wall comprises one of a nonwoven or cellulose.

7. The packaging article of claim 1, wherein the first wall and the second wall comprise:
an inner layer having a first major surface and opposing second major surface; and
an outer layer having a third major surface and opposing fourth major surface;
wherein the first major surface of the inner layer is the first interior surface, the second interior surface, or both and the fourth major surface of the outer layer is the first exterior surface, the second exterior surface, or both.

8. The packaging article of claim 7, further comprising an intermediate layer between the inner layer and the outer layer.

9. The packaging article of claim 1, wherein the first wall, the second wall, or both the first wall and the second wall are embossed in a repeating pattern.

10. The packaging article of claim 8, wherein the inner layer is embossed in a repeating pattern.

11. The packaging article of claim 1, wherein at least an adhesive portion is disposed on the second exterior surface and over any coating on the second exterior surface.

12. The packaging article of claim 11, wherein the adhesive portion or portions consist of a compostable adhesive.

13. The packaging article of claim 12, wherein the compostable adhesive comprises one or more of: a copolymer of 2-octylacrylate and acrylic acid, a copolymer of sugar-modified acrylates, a blend of polylactic acid and polycaprolactone, poly(hydroxyalkanoate), protein adhesive, natural rubber adhesive, and dimer acid containing polyamides.

14. The packaging article of claim 1, wherein the first wall further comprises a flap that is adapted to be folded between an open configuration and a closed configuration, and that extends beyond the opening of the packaging article in the open configuration and covers the opening in the packaging article in the closed configuration.

15. An assembly comprising the packaging article of claim 1 and an object located within the interior of the packaging article.

16. A method of making a packaging article of claim 1, comprising
folding a first compostable sheet having a heat sealable compostable coating to form a folded sheet, wherein a portion of the folded sheet on one side of the fold constitutes the first wall the a with one edge defined by a fold; and
sealing at least one additional edge to form the packaging article.
